(19) United States
(12) Patent Application Publication
(10) Pub. No.: US 2025/0030891 A1
(43) Pub. Date: Jan. 23, 2025

(54) DECODING METHOD, ENCODING METHOD, AND DECODING DEVICE

(71) Applicant: Panasonic Intellectual Property Corporation of America, Torrance, CA (US)

(72) Inventors: Takahiro NISHI, Nara (JP); Toshiyasu SUGIO, Osaka (JP); Noritaka IGUCHI, Osaka (JP)

(21) Appl. No.: 18/909,385

(22) Filed: Oct. 8, 2024

Related U.S. Application Data
(63) Continuation of application No. PCT/JP2023/009625, filed on Mar. 13, 2023.
(60) Provisional application No. 63/332,477, filed on Apr. 19, 2022.
(60) Provisional application No. 63/330,457, filed on Apr. 13, 2022.

(51) Int. Cl. H04N 19/597; H04N 19/124; H04N 19/159; H04N 19/70; H04N 19/91

(52) U.S. Cl. CPC H04N 19/597; H04N 19/124; H04N 19/159; H04N 19/70; H04N 19/91

(57) ABSTRACT

A decoding method is a decoding method for decoding encoded three-dimensional points each having position information including a distance component, a first direction component, and a second direction component, and includes: determining at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and performing processing that uses the at least one method determined.

### CROSS REFERENCE TO RELATED APPLICATIONS

This application is a U.S. continuation application of PCT International Patent Application Number PCT/JP2023/009625 filed on Mar. 13, 2023, claiming the benefit of priority of U.S. Provisional Patent Application No. 63/330,457 filed on Apr. 13, 2022, and U.S. Provisional Patent Application No. 63/332,477 filed on Apr. 19, 2022, the entire contents of which are hereby incorporated by reference.

### FIELD

The present disclosure relates to a decoding method, an encoding method, and a decoding device, and an encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

In encoding processing and decoding processing of three-dimensional data, there is a demand for improving encoding efficiency and reducing the amount of data handled in a decoding device.

The present disclosure provides a decoding method, an encoding method, a decoding device, or an encoding device capable of improving encoding efficiency and reducing the amount of data handled in the decoding device.

### Solution to Problem

A decoding method according to an aspect of the present disclosure is a decoding method for decoding encoded three-dimensional points each having position information including a distance component, a first direction component, and a second direction component, and includes: determining at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and performing processing that uses the at least one method determined.

An encoding method according to an aspect of the present disclosure is an encoding method for encoding three-dimensional points each having position information including a distance component, a first direction component, and a second direction component, and includes: determining at least one method out of an entropy encoding method or a binarization method for information on a first three-dimensional point, according to a total number of second three-dimensional points each having a first direction component and a second direction component that are respectively and substantially equal to a first direction component and a second direction component of the first three-dimensional point, the first three-dimensional point being included among the three-dimensional points, the second three-dimensional points being included among encoded three-dimensional points; and performing processing that uses the at least one method determined.

### Advantageous Effects

The present disclosure can provide a decoding method, an encoding method, a decoding device, or an encoding device capable of improving encoding efficiency and reducing the amount of data handled in the decoding device.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of a three-dimensional data encoding device according to an embodiment.

FIG. 2 is a block diagram of a three-dimensional data decoding device according to the embodiment.

FIG. 3 is a diagram illustrating an example of a point cloud according to an embodiment.

FIG. 4 is a flowchart of arithmetic encoding processing or arithmetic decoding processing according to the embodiment.

FIG. 5 is a diagram illustrating an example of a syntax of node information of a three-dimensional point according to the embodiment.

FIG. 6 is a flowchart of a variation of arithmetic encoding processing or arithmetic decoding processing according to the embodiment.

FIG. 7 is a flowchart of a variation of arithmetic encoding processing or arithmetic decoding processing according to the embodiment.

FIG. 8 is a diagram illustrating an example of a point cloud according to the embodiment.

FIG. 9 is a flowchart of a variation of arithmetic encoding processing or arithmetic decoding processing according to the embodiment.

FIG. 10 is a diagram illustrating an encoding order of three-dimensional points according to the embodiment.

FIG. 11 is a diagram illustrating an example of a syntax of geometry information according to the embodiment.

FIG. 12 is a diagram illustrating an example of a syntax of geometry information according to the embodiment.

FIG. 13 is a diagram illustrating a reference range during context selection according to the embodiment.

FIG. 14 is a flowchart of a variation of arithmetic encoding processing or arithmetic decoding processing according to the embodiment.

FIG. 15 is a flowchart of a three-dimensional data encoding method according to the embodiment.

FIG. 16 is a flowchart of a three-dimensional data decoding method according to the embodiment.

### DESCRIPTION OF EMBODIMENTS

A decoding method according to an aspect of the present disclosure is a decoding method for decoding encoded three-dimensional points each having position information including a distance component, a first direction component, and a second direction component, and includes: determining at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and performing processing that uses the at least one method determined.

Accordingly, the total number of decoded second three-dimensional points is reset upon switching of a direction component. In response, the decoding method switches at least one method out of the entropy decoding method or the debinarization method. Switching of a direction component means that at least one of the first direction component or the second direction component is switched. The decoding method can thus select, for example, at least one method out of the entropy decoding method or the debinarization method as appropriate for the switching of the direction component. The decoding method can therefore appropriately decode a bitstream encoded with an improved encoding efficiency. The improved encoding efficiency of the bitstream can also reduce the amount of data handled in a decoding device. It should be noted that direction components being substantially equal to each other means that the difference between the direction components is smaller than or equal to a threshold, for example.

For example, in the determining, a context to be used in arithmetic decoding may be determined; and in the processing, the information may be arithmetic-decoded using the context determined.

Accordingly, the decoding method can switch, according to the switching of the direction component, the context to be used in arithmetic decoding. The decoding method can thus select, for example, a context suitable for the switching of the direction component. The decoding method can therefore appropriately decode a bitstream encoded with an improved encoding efficiency. The improved encoding efficiency of the bitstream can also reduce the amount of data handled in the decoding device. It should be noted that the entropy decoding is not limited to arithmetic decoding. For example, the entropy decoding may be Huffman decoding.

For example, the information may indicate which between an inter prediction mode and an intra prediction mode is to be used.

For points having substantially equal direction components (the first direction component and the second direction component), the intra prediction mode tends to be consecutively selected. The decoding method thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the information may indicate a prediction residual of the first direction component or the second direction component.

For points having substantially equal direction components (the first direction component and the second direction component), the prediction residual tends to decrease. The decoding method thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the prediction residual may be information obtained by quantizing a prediction residual of a horizontal angle component.

For points having substantially equal direction components (the first direction component and the second direction component), the prediction residual of the horizontal angle component tends to decrease. The decoding method thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the total number may be a total number of the second three-dimensional points each having a quantized first direction component and a quantized second direction component that are respectively and substantially equal to a quantized first direction component and a quantized second direction component of the first encoded three-dimensional point.

For example, in the determining, the total number may be clipped at a predetermined upper limit, and the at least one method may be determined according to the total number clipped.

Accordingly, for example, in the case of switching methods for each total number, the number of methods to be used can be reduced, and thus the processing amount or the memory capacity to be used can be reduced.

For example, in the determining, the total number of the second three-dimensional points may be quantized, and the at least one method may be determined according to the total number quantized.

Accordingly, for example, in the case of switching methods for each total number, the number of methods to be used can be reduced, and thus the processing amount or the memory capacity to be used can be reduced.

For example, in the determining: when the total number is not within a predetermined range, the at least one method may be determined according to the total number; and when the total number is within the predetermined range, the at least one method may be determined according to history information based on information on the decoded three-dimensional points.

Accordingly, even if there are cases where switching methods according to the total number is not effective, the decoding method can select an appropriate method using the history information. Furthermore, since the number of methods to be used can be reduced compared to the case of switching the method for each combination of a total number and history information, the processing amount or the memory capacity to be used can be reduced.

For example, the history information may be a total number of 0s or 1s or a pattern of the 0s and the 1s in the information on the decoded three-dimensional points.

Accordingly, the decoding method can select an appropriate method according to the total number of 0s or 1s or the pattern of the 0s and 1s in the information on the decoded three-dimensional points.

For example, the history information may be updated with the information on a decoded three-dimensional point for which the total number is a predetermined value, and need not be updated with the information of a decoded three-dimensional point for which the total number is other than the predetermined value.

Accordingly, for example, the decoding method can allow the history information to reflect information on points expected to have high correlation. The decoding method can therefore appropriately decode a bitstream encoded with an improved encoding efficiency. The improved encoding efficiency of the bitstream can also reduce the amount of data handled in the decoding device.

For example, the information may indicate whether a three-dimensional point corresponding to a reference position is present.

Here, at the time of switching of the direction component, information indicating whether a three-dimensional point corresponding to a reference position is present tends to be a specific value. The decoding method thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

An encoding method according to an aspect of the present disclosure is an encoding method for encoding three-dimensional points each having position information including a distance component, a first direction component, and a second direction component, and includes: determining at least one method out of an entropy encoding method or a binarization method for information on a first three-dimensional point, according to a total number of second three-dimensional points each having a first direction component and a second direction component that are respectively and substantially equal to a first direction component and a second direction component of the first three-dimensional point, the first three-dimensional point being included among the three-dimensional points, the second three-dimensional points being included among encoded three-dimensional points; and performing processing that uses the at least one method determined.

Accordingly, the total number of encoded second three-dimensional points is reset upon switching of a direction component. In response, the encoding method switches at least one method out of the entropy encoding method or the binarization method. Switching of a direction component means that at least one of the first direction component or the second direction component is switched. The encoding method can thus select, for example, at least one method out of the entropy encoding method or the binarization method as appropriate for the switching of the direction component, and thus encoding efficiency can be improved.

A decoding device according to an aspect of the present disclosure decodes encoded three-dimensional points each having position information including a distance component, a first direction component, and a second direction component, and includes: a processor; and memory. Using the memory, the processor: determines at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and performs processing that uses the at least one method determined.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### EMBODIMENT

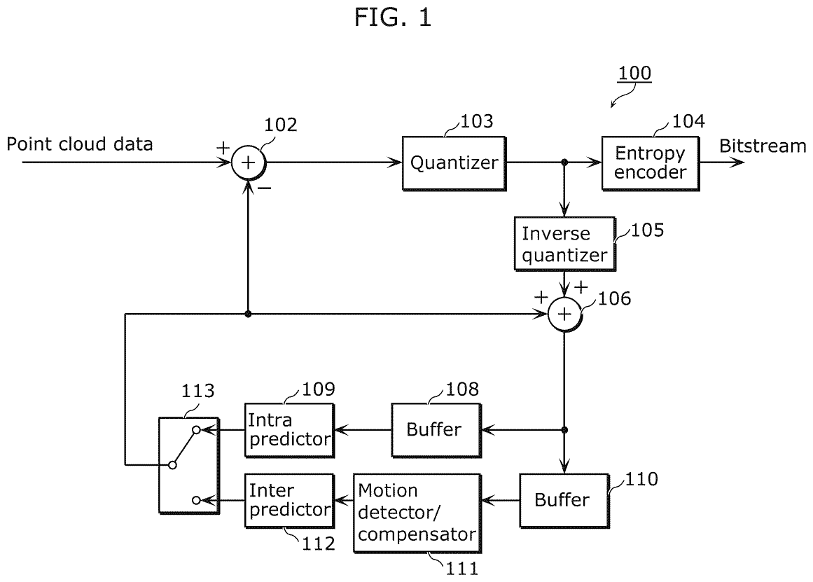

First, a configuration of a three-dimensional data encoding device and a three-dimensional data decoding device according to the present embodiment will be described. FIG. 1 is a block diagram illustrating the configuration of three-dimensional data encoding device 100. Three-dimensional data encoding device 100 encodes a point cloud which is three-dimensional data to thereby generate a bitstream (an encoded stream).

A point cloud, which is a set of three-dimensional points, represents the three-dimensional shape of an object. The point cloud data includes position information and attribute information on the three-dimensional points. The position information indicates the three-dimensional position of each three-dimensional point. It should be noted that the position information may also be called geometry information.

For example, position information is represented using a polar coordinate system and includes one distance component and two direction components (angle components). Specifically, position information includes distance d, elevation angle θ, and horizontal angle Φ. Point cloud data is, for example, data obtained by a laser sensor such as LiDAR, and the like. It should be noted that position information may be represented using an orthogonal coordinate system (x, y, z).

The attribute information indicates, for example, attributes such as the color, reflectance, and normal vector. One three-dimensional point may have one item of attribute information or may have a plurality of items of attribute information.

The three-dimensional data is not limited to point cloud data and may be other types of three-dimensional data, such as mesh data. Mesh data (also called three-dimensional mesh data) is a data format used for computer graphics (CG) and represents the three-dimensional shape of an object as a set of surface information items. For example, mesh data includes point cloud information (e.g., vertex information), which may be processed by techniques similar to those for point cloud data.

It should be noted that although FIG. 1 illustrates processing units related to the encoding of position information of point cloud data, three-dimensional data encoding device 100 may include other processing units such as processing units that perform encoding of attribute information, and so on.

Three-dimensional data encoding device 100 includes subtractor 102, quantizer 103, entropy encoder 104, inverse quantizer 105, adder 106, buffer 108, intra predictor 109, buffer 110, motion detector/compensator 111, inter predictor 112, and switcher 113.

Subtractor 102 subtracts a prediction value from position information included in input point cloud data to be encoded to generate a prediction residual. Quantizer 103 quantizes the prediction residual. Entropy encoder 104 entropy-encodes the quantized prediction residual to generate a bitstream. Entropy encoder 104 also entropy-encodes control information and adds the encoded information to the bitstream.

Inverse quantizer 105 inverse-quantizes the quantized prediction residual generated by quantizer 103 to generate a prediction residual. Adder 106 adds the prediction value to the prediction residual generated by inverse quantizer 105 to reproduce the position information. Buffer 108 retains the reproduced position information as a reference point cloud for intra prediction. Buffer 110 retains the reproduced position information as a reference point cloud for inter prediction.

It should be noted that there is a possibility that the reproduced position information includes a quantization error and therefore does not perfectly agree with the original position information. It should be noted that a three-dimensional point reproduced by encoding processing and decoding processing is referred to as an encoded three-dimensional point, a decoded three-dimensional point or a processed three-dimensional point.

Intra predictor 109 calculates a prediction value using position information of one or more reference points, which are other three-dimensional points belonging to the same frame as a three-dimensional point to be processed (referred to as a current point hereinafter) and are already processed. For example, intra predictor 109 performs intra prediction using a prediction tree. The prediction tree is a tree structure that indicates a reference relationship in prediction processing. For example, in prediction processing of a current node (current point), position information of a parent node is referred to. It should be noted that in prediction processing, position information of a plurality of nodes (such as a grandparent node or a great-grandparent node) including a parent node may be referred to.

Motion detector/compensator 111 detects a displacement between a current frame, which is a frame including a current point, and a reference frame, which is a frame other than the current frame, (motion detection) and corrects position information of a point cloud included in the reference frame based on the detected displacement Information indicating the detected (motion compensation). displacement (motion information) is stored in the bitstream, for example.

Inter predictor 112 calculates a prediction value using position information of one or more reference points included in a point cloud subjected to the motion compensation. It should be noted that the motion detection and the motion compensation need not be performed.

Switcher 113 selects one of the prediction value calculated by intra predictor 109 and the prediction value calculated by inter predictor 112, and outputs the selected prediction value to subtractor 102 and adder 106. That is, switcher 113 switches whether to use intra prediction or to use inter prediction. For example, this switching may be based on comparing the cost (code amount) involved in using intra prediction and the cost involved in using inter prediction, and selecting the lower-cost scheme. Alternatively, this switching may be based on an external instruction, or based on the point cloud or information associated with the point cloud. Information indicating whether intra prediction is used or inter prediction is used is stored in the bitstream.

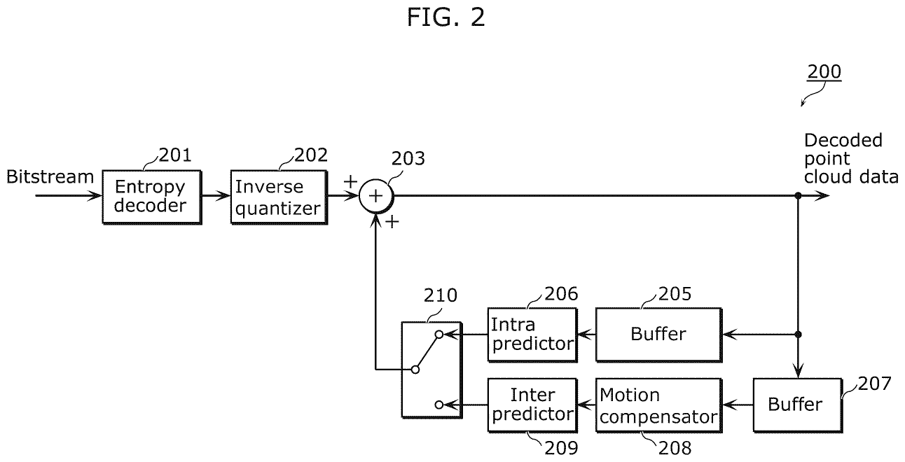

Next, a configuration of three-dimensional data decoding device 200 that decodes the bitstream generated by three-dimensional data encoding device 100 described above will be described. FIG. 2 is a block diagram of three-dimensional data decoding device 200 according to the present embodiment. It should be noted that although FIG. 2 shows a processor concerning decoding of position information of a point cloud, three-dimensional data decoding device 200 may include another processor, such as a processor that performs decoding or the like of attribute information of a point cloud. For example, three-dimensional data decoding device 200 generates decoded point cloud data by decoding the bitstream generated by three-dimensional data encoding device 100 shown in FIG. 1.

Three-dimensional data decoding device 200 includes entropy decoder 201, inverse quantizer 202, adder 203, buffer 205, intra predictor 206, buffer 207, motion compensator 208, inter predictor 209, and switcher 210.

Three-dimensional data decoding device 200 obtains the bitstream generated by three-dimensional data encoding device 100.

Entropy decoder 201 entropy-decodes the bitstream to generate a quantized prediction residual and control information.

Inverse quantizer 202 inverse-quantizes the quantized prediction residual generated by entropy decoder 201 to generate a prediction residual. Adder 203 adds a prediction value to the prediction residual generated by inverse quantizer 202 to reproduce the position information. The position information is output as decoded point cloud data.

Buffer 205 retains the decoded position information as a reference point cloud for intra prediction. Buffer 207 retains the reproduced position information as a reference point cloud for inter prediction. Intra predictor 206 calculates a prediction value using position information of one or more reference points, which are other three-dimensional points belonging to the same frame as the current point. For example, intra predictor 206 performs intra prediction using a prediction tree.

Motion compensator 208 obtains, from the bitstream, motion information indicating a displacement between a current frame and a reference frame and corrects position information of a point cloud included in the reference frame based on the displacement indicated by the motion information (motion compensation). Inter predictor 209 calculates a prediction value using position information of one or more reference points included in the point cloud subjected to the motion compensation. It should be noted that the motion compensation need not be performed.

Switcher 210 selects one of the prediction value calculated by intra predictor 206 and the prediction value calculated by inter predictor 209, and outputs the selected prediction value to adder 203. For example, this switching is based on the information in the bitstream indicating whether intra prediction is used or inter prediction is used.

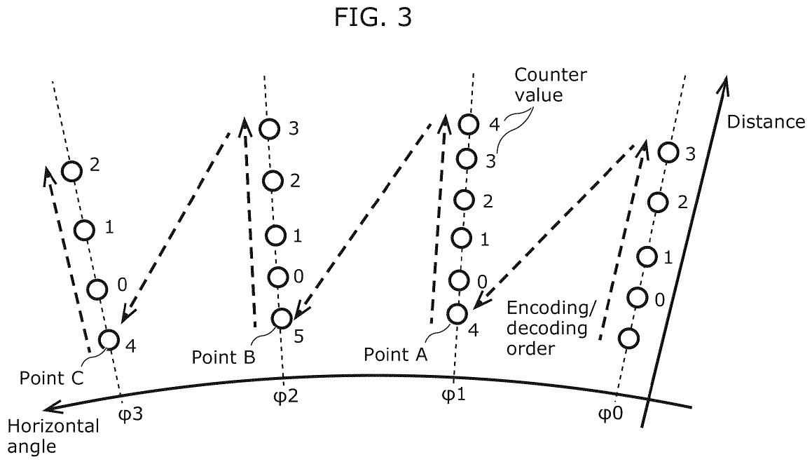

Now, a method of entropy-encoding each point in a prediction tree will be described. FIG. 3 is a diagram illustrating an example of a point cloud obtained by LiDAR, showing a top view of the point cloud. In this example, the position of each point is represented by polar coordinates, that is, a distance component and two direction components. Being a top view, FIG. 3 does not show the elevation angle.

The point cloud shown in FIG. 3 is an example of a point cloud obtained in an operation mode that may be called multi-return, in which laser pulses reflected off object surfaces are detected and are each regarded as a point. In multi-return, points behind translucent points (objects) can be detected, for example, so that points at different distances exist in the same angular direction (e.g., at each of the horizontal angles ϕ0 to ϕ3). The points shown in FIG. 3 have the same elevation angle, for example.

Dashed arrows shown are an example of the order of encoding or decoding the points. Points at the same angle are encoded in ascending order (or descending order) of distance. This increases correlation among residual information items in intra prediction, thereby improving the efficiency of the entropy encoding (e.g., arithmetic encoding) of the residual information.

Although the example here illustrates four to six points in the same angular direction, two or more points may exist in the same angular direction. Not all of the angular directions need to have points, and at least one angular direction may have two or more points.

The point cloud, serving as an example in which points at different distances exist in the same angular direction, is described above as being obtained by multi-return. Points having the same angular component, however, may also result from quantizing the direction components (the horizontal angle and the elevation angle). Such points may be similarly addressed by the techniques in this embodiment.

In the encoding of points in the same angular direction, a first prediction scheme (e.g., intra prediction) is consecutively selected. Therefore, for example, intra_pred_flag tends to be consecutively set to a first value (e.g., true (the value 1)). Here, intra_pred_flag indicates whether the prediction scheme applied to the encoding or decoding of the current point is intra prediction or not (i.e., whether it is intra prediction or inter prediction). For example, the value 1 indicates intra prediction, and the value 0 indicates inter prediction.

As the first prediction scheme is consecutively selected as above, the context for the arithmetic encoding is updated to a state suitable for the first prediction scheme. At the points immediately after the encoding process transitions to the next angular direction, such as points A to C (i.e., the first point in the encoding order in each angular direction), a second prediction scheme (e.g., inter prediction) different from the first prediction scheme would be able to reduce the amount of residual information more than the first prediction scheme. However, due to the above update, the code amount is not sufficiently reduced for intra_pred_flag indicating the second prediction scheme. The encoding device therefore tends to select the first prediction scheme for such points and fails to sufficiently improve the encoding efficiency.

To address this problem, a three-dimensional data encoding device or a three-dimensional data decoding device uses a counter value to select a context to be used to arithmetic-encode or arithmetic-decode a syntax element corresponding to each point. The counter value is assigned to each point according to the total number of points located in the same angular direction, as in FIG. 3. The syntax element is, for example, intra_pred_flag or quantized_1st_residual_value[j]. quantized_1st_residual_value[j] (j is 0 to 2) indicates a quantized value (quantized prediction residual) of the prediction residual of each direction component, among the prediction residuals (difference information) between the coordinate values of the current point to be encoded or decoded and the coordinate values (prediction values) of the prediction point.

For example, the three-dimensional data encoding device generates quantized_1st_residual_value[j] (j is 0 or 1) by using a quantization step value to quantize the prediction residual of the horizontal angle component and the prediction residual of the elevation angle component.

In the example shown in FIG. 3, the counter value increments by one each time a point is encoded or decoded. The counter value is reset to 0 after the point immediately after the encoding process transitions to the next angular direction, such as each of points A to C, is encoded or decoded. That is, in this example, a different context is selected each time a point is encoded or decoded, and, after the point immediately after the encoding process transitions to the next angular direction is encoded or decoded, the context is reset to a context corresponding to the counter value 0. In still other words, in this example, a different context is selected according to the total number of encoded or decoded points in a horizontal angle, and, if the total number of encoded or decoded points in the angular direction is one, the context is reset to a context corresponding to the counter value 0.

In this manner, an appropriate context can be set according to the prediction residual of each of the points having the same horizontal and elevation angles and located at different distances. For example, for points with smaller counter values, the context is updated to a state suitable for the frequently selected first prediction scheme. For points with greater counter values, the context is updated to a state suitable for the second prediction scheme, or to a state that is neutral for both the first and second prediction schemes. This can improve the encoding efficiency of the first point in the encoding or decoding order in an angular direction, while maintaining the encoding efficiency of points in the same angular direction encoded using the first prediction scheme. Accordingly, it may be possible to improve the encoding efficiency for the bitstream as a whole.

Thus, as the counter value is smaller, a context in a state suitable for the first prediction scheme is more dominant; as the counter value is greater, a context in a state suitable for the second prediction scheme is more dominant. The context for each point is switched so that a context in a state suitable for the first prediction scheme is the most dominant after the point immediately after the encoding process transitions to the next angular direction is encoded or decoded.

Switching the context means selecting a context to be used from multiple contexts. Each context may be a context with probability update, or a context with a fixed probability. For a context with probability update, the probability is updated according to the value (0 or 1) of an arithmetic-encoded signal; in subsequent arithmetic encoding processing that uses the same context, the updated probability is used.

A context in a state suitable for a prediction scheme means a context that tends to reduce the code amount when the prediction scheme is used compared with when the prediction scheme is not used. Specifically, if contexts with probability update are used, the probability is automatically updated as the encoding or decoding process proceeds. Therefore, if a certain scheme tends to be used more frequently, the contexts are updated to a state suitable for the scheme. The default value of the probability may be a predetermined value (e.g., 0 and 1 have the same occurrence probability), or may be a value suitable for the scheme. That is, different contexts may have different default probability values according to their corresponding counter values. For example, contexts corresponding to smaller counter values may have default values more suitable for the first prediction scheme, whereas contexts corresponding to greater counter values may have default values more suitable for the second prediction scheme.

If contexts with a fixed probability are used, for example, contexts corresponding to smaller counter values may be in states more suitable for the first prediction scheme, whereas contexts corresponding to greater counter values may be in states more suitable for the second prediction scheme.

In the example shown in FIG. 3, the counter value of the first point in the encoding or decoding order in an angular direction depends on the total number of points in the immediately preceding angular direction. The counter value of the second point or a further subsequent point in the encoding or decoding order in an angular direction depends on how many points precede the point in the angular direction. Considering the above-described problem, it would be preferred that the counter value of the first point in the encoding or decoding order in an angular direction also depends on how many points precede the point in the angular direction. However, the three-dimensional data decoding device cannot determine the angular direction of the point at the stage of decoding the point (i.e., before decoding the point), nor can determine that the point is the first point in the angular direction. For these reasons, the example shown in FIG. 3 has a configuration such that the second point in an angular direction has the counter value 0.

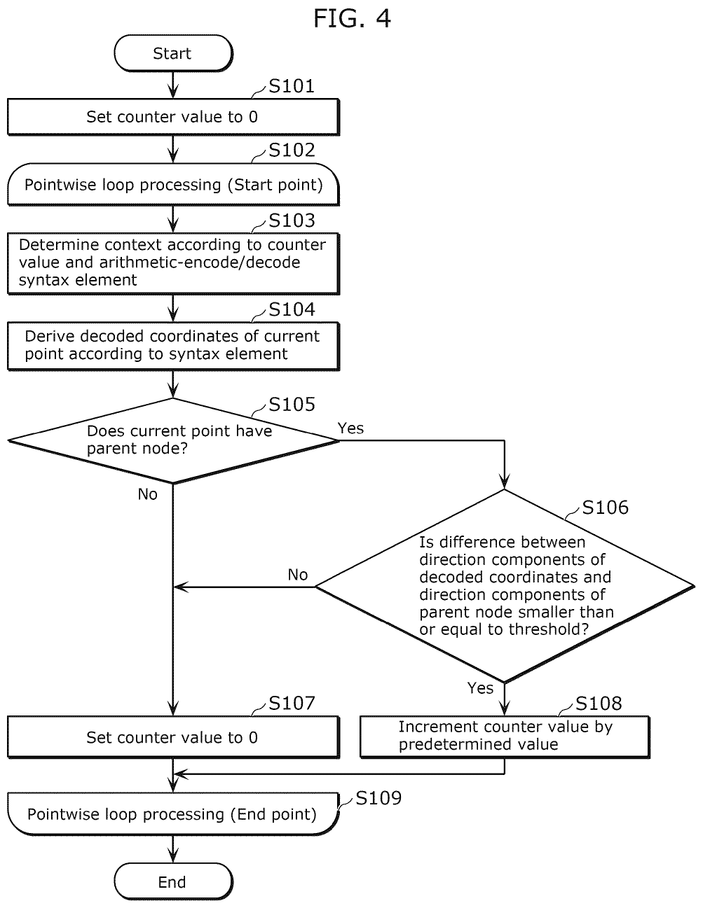

FIG. 4 is a flowchart illustrating an example of a procedure of using the counter value described with reference to FIG. 3 to arithmetic-encode or arithmetic-decode a syntax element corresponding to the current point to be encoded or decoded. Although the description here mainly focuses on the operations of the three-dimensional data encoding device, it also applies to the operations of the three-dimensional data decoding device. The operations of the three-dimensional data decoding device may be described by replacing encoding in the following description with decoding.

In this example, first, the three-dimensional data encoding device sets the counter value to the default value 0 (S101). The three-dimensional data encoding device then starts pointwise loop processing for the points in a prediction tree being processed (being encoded or decoded) (S102).

The three-dimensional data encoding device determines a context according to the counter value and, using the context determined, arithmetic-encodes the syntax element (S103). For example, each counter value may be assigned a context, so that the three-dimensional data encoding device may select, from multiple contexts, the context corresponding to the counter value.

The three-dimensional data encoding device may quantize the counter value and select the context based on the quantized counter value. That is, each range of counter values may be assigned a context, so that the three-dimensional data encoding device may select, from multiple contexts, the context corresponding to the range that includes the counter value. This can reduce the number of contexts used, thereby reducing the memory capacity for storing the contexts.

To encode multiple syntax elements of the current point, the three-dimensional data encoding device may perform the above context determination and arithmetic encoding for each syntax element.

According to the syntax element arithmetic-encoded at step S103, the three-dimensional data encoding device derives decoded coordinates of the current point (S104). If the decoded coordinates are to be different from the coordinates before encoding, the three-dimensional data encoding device derives the decoded coordinates of the current point by decoding the encoded information. This allows both the three-dimensional data encoding device and the three-dimensional data decoding device to use the same coordinates (decoded coordinates).

If the encoding process and the decoding process are to produce no differences between the coordinates before encoding and the decoded coordinates (lossless encoding and decoding), the three-dimensional data encoding device may skip the processing at step S104 and, in the subsequent processing, refer to the coordinates before encoding instead of the decoded coordinates.

In the three-dimensional data decoding device, the syntax element is decoded at step S103, and the decoded coordinates of the current point are derived according to the decoded syntax element at step S104.

The three-dimensional data encoding device determines whether the current point is the first point in the encoding or decoding order in the corresponding angular direction. Specifically, the three-dimensional data encoding device determines whether the current point has a parent node in the prediction tree (S105). If the current point has the parent node (Yes at S105), the three-dimensional data encoding device determines whether or not the difference between the direction components (the horizontal angle and the elevation angle) of the decoded coordinates of the current point and the direction components of the parent node is smaller than or equal to a threshold (S106).

For example, if (1) a first difference between the horizontal angle of the decoded coordinates of the current point and the horizontal angle of the parent node is smaller than or equal to a first threshold and if (2) a second difference between the elevation angle of the decoded coordinates of the current point and the elevation angle of the parent node is smaller than or equal to a second threshold, the three-dimensional data encoding device determines that the difference between the direction components of the decoded coordinates of the current point and the direction components of the parent node is smaller than or equal to the threshold. Otherwise, the device determines that the difference between the direction components of the decoded coordinates of the current point and the direction components of the parent node is greater than the threshold. The first threshold and the second threshold may be the same value or different values. Alternatively, the three-dimensional data encoding device may compare a value calculated from the first difference and the second difference, such as the sum, average, or weighted sum of the first difference and the second difference, with a threshold.

If the current point does not have the parent node (No at S105), or if the difference between the direction components of the decoded coordinates and the direction components of the parent node is greater than the threshold (No at S106), the three-dimensional data encoding device determines that the current point is the first point in the encoding order in the angular direction, and resets the counter value to 0 (S107).

If the difference between the direction components of the decoded coordinates and the direction components of the parent node is smaller than or equal to the threshold (Yes at S106), the three-dimensional data encoding device determines that the current point is the second point or a further subsequent point in the encoding order in the angular direction, and increments the counter value by a predetermined value (S108). The three-dimensional data encoding device then terminates the pointwise loop processing (S109). Thus, the processing at steps S103 to S108 is repeated for each point to arithmetic-encode or arithmetic-decode the points in the prediction tree.

Each threshold used at step S106 may be set based on the sampling interval or the resolution used for the corresponding one of the direction components of the sensor. For example, the threshold may be set to a value of approximately half the sampling interval or the resolution.

The predetermined value at step S108 may be “1,” or may be “the number of duplicated points+1” in view of the number of duplicated points that may result from down-converting the input point cloud (points having the same coordinates as the current point and having only color or reflectance encoded or decoded). The counter value may have an upper limit; if the counter value incremented by the predetermined value exceeds the upper limit, the counter value may be clipped at the upper limit. This can reduce the number of contexts used, thereby reducing the memory capacity for storing the contexts.

Thus, the contexts used for points with smaller counter values are updated to a state suitable for the frequently selected first prediction scheme. The contexts for points with greater counter values are updated to a state suitable for the second prediction scheme, or to a state that is neutral for both the first and second prediction schemes. This can improve the encoding efficiency of the first point in the encoding or decoding order in an angular direction, while maintaining the encoding efficiency of points in the same angular direction encoded using the first prediction scheme. Accordingly, it may be possible to improve the encoding efficiency for the bitstream as a whole.

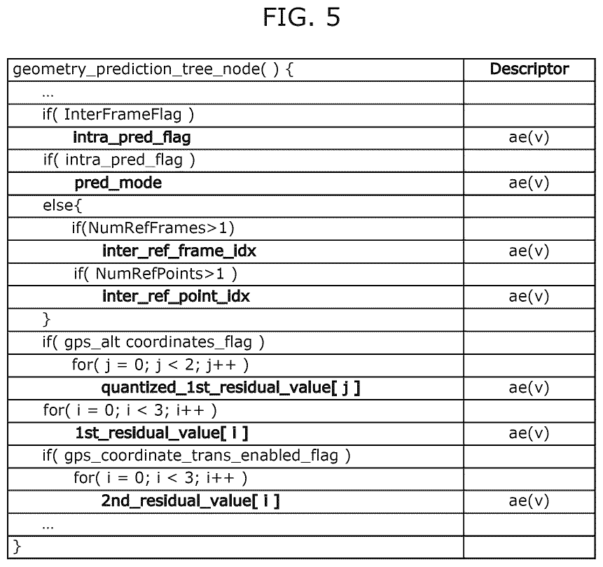

FIG. 5 is a diagram illustrating an example of a syntax of node information (geometry_prediction_tree_node) on a three-dimensional point according to the embodiment. This syntax is an example of information on each node in a prediction tree.

InterFrameFlag indicates whether inter prediction can be used. InterFrameFlag is set according to a higher-level syntax (such as the SPS, GPS, or slice header). The SPS (Sequence Parameter Set) is a parameter set (control information) for each sequence including multiple frames. The SPS is also a parameter set common to position information and attribute information. The GPS (Geometry Parameter Set) is a parameter set for each frame and is a parameter set for position information.

intra_pred_flag indicates whether the prediction scheme applied to encoding or decoding the current point is intra prediction or not (i.e., whether it is intra prediction or inter prediction). For example, the value 1 indicates intra prediction, and the value 0 indicates inter prediction.

For example, intra_pred_flag is included in the node information if InterFrameFlag indicates that inter prediction can be used, and not included in the node information if InterFrameFlag indicates that inter prediction cannot be used (is disabled).

If intra prediction is applied (intra_pred_flag=1), the node information includes pred_mode. pred_mode indicates the prediction mode applied to encoding or decoding the current point. The prediction mode is information indicating how an intra prediction point for the current point is determined. For example, the prediction mode indicates the manner in which the prediction point is calculated based on the position(s) of one or more higher nodes for the current node in the prediction tree.

If inter prediction is applied (intra_pred_flag=0), the node information includes one or more items of inter_ref_frame_idx and one or more items of inter_ref_point_idx.

NumRefFrames indicates the number of frames (point clouds) referred to in inter prediction, and is set according to a higher-level syntax (such as the SPS, GPS, or slice header).

inter_ref_frame_idx is included in the node information if inter prediction is applied (intra_pred_flag=0) and if NumRefFrames is greater than 1. inter_ref_frame_idx indicates each frame referred to in the inter prediction of the current point.

NumRefPoints indicates the number of prediction points referred to in inter prediction. inter_ref_point_idx is included in the node information if inter prediction is applied (intra_pred_flag=0) and if NumRefPoints is greater than 1. inter_ref_point_idx indicates each prediction point referred to in the inter prediction of the current point.

gps_alt_coordinates_flag indicates whether the encoding or decoding processing of the point cloud is performed using orthogonal coordinates (the value 0) or coordinates different from orthogonal coordinates (e.g., coordinates) polar (the value 1). gps_alt_coordinates_flag is added to the bitstream.

If gps_alt_coordinates_flag indicates the use of polar coordinates (e.g., gps_alt_coordinates_flag=1), the node information includes quantized_1st_residual_value[j].

quantized_1st_residual_value[j] (j is 0 to 2) indicates a quantized value (quantized prediction residual) of the prediction residual of each direction component, among the prediction residuals (difference information) between the coordinate values of the current point to be encoded or decoded and the coordinate values (prediction values) of the prediction point.

For example, the three-dimensional data encoding device generates quantized_1st_residual_value[j] (j is 0 or 1) by using a quantization step value to quantize the prediction residual of the horizontal angle component and the prediction residual of the elevation angle component. Information indicating the quantization step value is stored in, for example, a higher-level syntax (such as the SPS, GPS, or slice header) in the bitstream.

In addition to quantized_1st_residual_value[j], the three-dimensional data encoding device may store, in the bitstream, a remainder component that is the difference between the unquantized prediction residual and the quantized prediction residual (quantized value). For example, this remainder component may be stored as 1st_residual_value[i] in the bitstream.

Specifically, the remainder component of each of the horizontal angle and the elevation angle may be stored in the bitstream as 1st_residual_value of each of the horizontal angle and the elevation angle.

Thus, in encoding point cloud data obtained by a sensor that changes the sensing direction at a certain speed, the three-dimensional data encoding device may be able to reduce the code amount of the prediction residuals of the direction components by setting a quantization step value according to the speed. The three-dimensional data encoding device may encode point cloud data generated with a sensor, for example a rotationally scanning laser sensor such as a LiDAR sensor, that obtains the three-dimensional positions of an object in the surrounding area while rotating in one direction. In such a case, for one of the direction components (e.g., the horizontal angle) in the same direction as the rotation direction of the sensor, the device may store the quantized value and the remainder component in the bitstream. For the other direction component (e.g., the elevation angle) and the distance component, the device may store only the quantized value or only the unquantized prediction residual (1st_residual_value) in the bitstream.

1st_residual_value[i] indicates the prediction residual of each of the components (the horizontal angle, elevation angle, and distance, or x, y, z) of the position information on the current point. If remainder components are stored in the bitstream as described above, 1st_residual_value[i] indicates the remainder component of each corresponding component.

gps_coordinate_trans_enabled_flag indicates whether the position coordinates are transformed or not before encoding or after decoding. If the coordinates are transformed (gps_coordinate_trans_enabled_flag=1), the three-dimensional data encoding device transforms the input position information in the orthogonal coordinate system into position information in the polar coordinate system and then encodes it. The three-dimensional data decoding device transforms the decoded position information in the polar coordinate system into position information in the orthogonal coordinate system and then outputs it.

If the coordinates are transformed (gps_coordinate_trans_enabled_flag=1), the node information includes 2nd_residual_value[i]. 2nd_residual_value[i] indicates the difference, yielded by the coordinate transform, between the position information in the orthogonal coordinate system and the position information in the polar coordinate system. The three-dimensional data decoding device adds this difference to the transformed position information in the orthogonal coordinate system resulting from transforming the decoded position information in the polar coordinate system. Thus, the original position information in the orthogonal coordinate system is reproduced.

The syntax element for which the context is selected according to the counter value in the process shown in FIG. 4 is, for example, at least one of the syntax elements shown in FIG. 5. For example, the three-dimensional data encoding device may select, according to the counter value, contexts for intra_pred_flag and quantized_1st_residual_value[j] shown in FIG. 5. For syntax elements other than intra_pred_flag and quantized_1st_residual_value[j], the three-dimensional data encoding device may, for example, use a common context irrespective of the counter value, rather than selecting a context according to the counter value. This can reduce the number of contexts used, thereby reducing the memory capacity for storing the contexts.

In the example shown in FIG. 4, steps S105 and S106 are used to determine whether the current point is the first point in the encoding order in the angular direction. However, other manners capable of determining whether the current point is the first point in the encoding order in the angular direction may also be used.

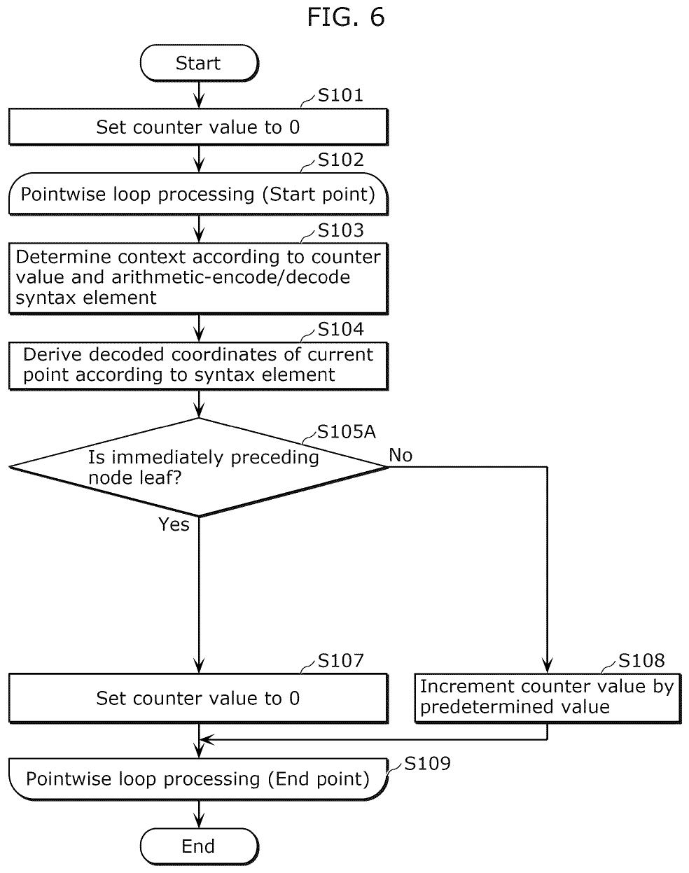

FIG. 6 is a flowchart illustrating a variation of the procedure of arithmetic-encoding or arithmetic-decoding a syntax element corresponding to the current point. The process shown in FIG. 6 is different from the process shown in FIG. 4 in that it includes S105A instead of steps S105 and S106.

For example, the prediction tree may be configured to branch at the first node in an angular direction and have the last node in the angular direction as a leaf node. Instead of performing steps S105 and S106, the three-dimensional data encoding device determines whether the immediately preceding encoded node is a leaf (S105A), thereby determining whether the current point is the first point in the encoding order in the angular direction. If the immediately preceding encoded node (point) is a leaf (Yes at S105A), the three-dimensional data encoding device performs step S107. If the immediately preceding encoded node is not a leaf (No at S105A), the device performs step S108. In this manner, the three-dimensional data encoding device can still set the counter values as in the example shown in FIG. 3.

In both the three-dimensional data encoding device and the three-dimensional data decoding device, whether the immediately preceding node is a leaf can be determined before the decoded coordinates of the current point is derived. Therefore, before performing step S103, the three-dimensional data encoding device may determine whether the immediately preceding encoded node is a leaf, and if so, perform step S107, and if not, perform step S108. In this case, the three-dimensional data encoding device can set the counter value of the first point in the encoding order in the angular direction (e.g., point A, B, or C in FIGS. 3) to 0.

Further, if determining whether the immediately preceding encoded node is a leaf before performing step S103, the three-dimensional data encoding device may determine the context without setting the counter value but according to whether the current point is the first point in the encoding order in the angular direction (i.e., whether the immediately preceding encoded node is a leaf).

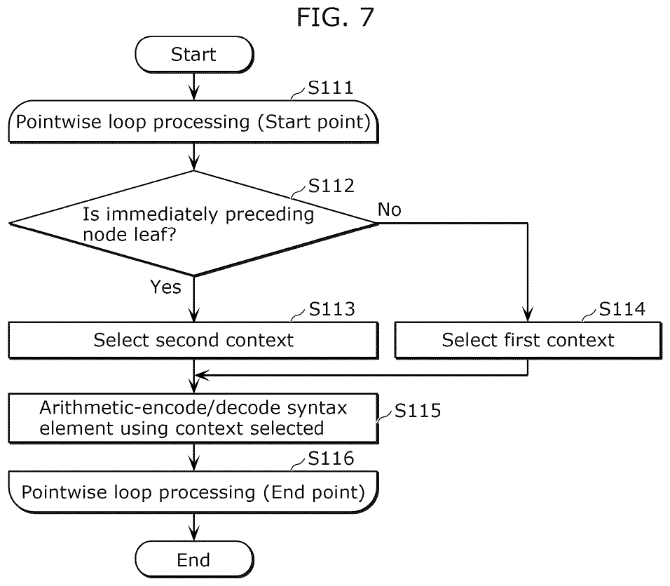

FIG. 7 is a flowchart of a variation of arithmetic encoding processing or arithmetic decoding processing according to the embodiment.

The three-dimensional data encoding device starts pointwise loop processing for the points in a prediction tree being processed (S111). The three-dimensional data encoding device determines whether the immediately preceding encoded node is a leaf (S112). If the immediately preceding encoded node is a leaf (Yes at S112), the three-dimensional data encoding device selects a second context that assumes that the second prediction scheme (e.g., inter prediction) is selected (S113). If the immediately preceding encoded node is not a leaf (No at S112), the three-dimensional data encoding device selects a first context that assumes that the first prediction scheme (e.g., intra prediction) is selected (S114).

Using the context selected at step S113 or S114, the three-dimensional data encoding device arithmetic-encodes the syntax element (S115). To encode multiple syntax elements, the three-dimensional data encoding device may perform the above context determination and arithmetic encoding for each syntax element. The three-dimensional data encoding device then terminates the pointwise loop processing (S116).

In the example shown in FIG. 4, the three-dimensional data encoding device performs the determination at steps S105 and S106 based on the parent node information. Instead of the parent node information, the determination may be based on information on the node encoded immediately before the current point.

The three-dimensional data encoding device performs the determination at step S106 using both the horizontal and elevation angles of the decoded coordinates. However, the determination may use only one of the horizontal and elevation angles. For example, if encoding the point while sequentially scanning points in the horizontal direction, the three-dimensional data encoding device may perform the determination using only the horizontal angle. If encoding the point while sequentially scanning points in the vertical direction, the three-dimensional data encoding device may perform the determination using only the elevation angle. The three-dimensional data encoding device may also perform the determination using a quantized horizontal angle or a quantized elevation angle.

It should be noted that all processes described with reference to FIG. 4 and so on, are not always necessary, and it is acceptable that only part of these processes are performed.

In the example shown in FIG. 3, the points are at the same elevation angle and each horizontal angle has points at different distances. Similar processing may also be performed in cases in which the points are at the same horizontal angle and each elevation angle has points at different distances. In such cases, for example, the points are encoded or decoded in ascending order of distance at each elevation angle.

In the example in FIG. 3, the points are encoded or decoded in ascending order of distance at each horizontal angle. However, the points may be encoded or decoded in descending order of distance.

In the above examples, the two direction components of each point are the horizontal angle component and the elevation angle component. However, the two directions are not limited to these directions and may be any two directions orthogonal to each other.

The counter value may be updated in manners different from the manner illustrated in the above examples. For example, although the counter value in the above examples is updated each time a point is processed (encoded or decoded), the counter value may be updated each time multiple points are processed. For example, step S106 may be performed each time the number of times of Yes at step S105 reaches a predetermined number, rather than each time step S105 results in Yes.

Further, the three-dimensional data encoding device may switch the context without using the counter value. For example, the three-dimensional data encoding device may use the first context if step S105 or S106 in FIG. 4 results in No, and use the second context if step S106 results in Yes.

The above examples assume that the predetermined value by which the counter value is incremented may be “the number of duplicated points+1”. However, this is not limiting. For example, the predetermined value may be greater than “the number of duplicated points+1” so that the context is more likely to be switched after the duplicated points are encoded or decoded.

The above description illustrates that an angular direction has multiple points at different distances, as shown in FIG. 3. In addition to such cases, the above processing may be applied to cases in which an angular direction may have only one point.

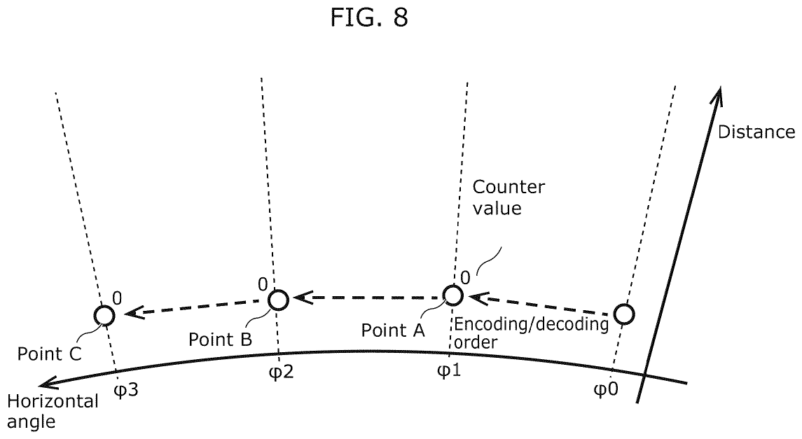

FIG. 8 is a diagram illustrating an example of a point cloud obtained by LiDAR. FIG. 8, like FIG. 3, is a top view of the point cloud. In this example, the position of each point is represented by polar coordinates, that is, a distance component and two direction components. Being a top view, FIG. 8 does not show the elevation angle.

In this example, unlike in the example in FIG. 3, each angular direction (e.g., each of the horizontal angles ϕ0 to ϕ3) has one point. That is, this point cloud is an example of a point cloud obtained by, for example, single-return. Single-return is an operation mode in which only one point is detected per angular direction. The points shown in FIG. 8 have the same elevation angle. Dashed arrows shown are an example of the order of encoding or decoding the points.

The processing shown in the flowchart in FIG. 4 may be applied to the point cloud shown in FIG. 8. Because the difference between the direction components of the decoded coordinates and the direction components of the parent node is greater than the threshold (No at S106), points A, B, and C are assigned the counter value=0.

The points in the adjacent angular directions shown in FIG. 8 may be assumed to belong to the same object surface and are often highly correlated with each other. Therefore, a certain degree of correlation is observed in the prediction mode (e.g., intra_pred_flag shown in FIG. 5) used for the points in the adjacent angular directions. Utilizing this characteristic, the three-dimensional data encoding device may maintain, as history information, the value(s) of one or more encoded items of intra_pred_flag and use the history information to select the context for the arithmetic encoding of intra_pred_flag. The history information here is, for example, the number of points having intra_pred_flag of 0 or 1 among a predetermined number of immediately preceding encoded points. Alternatively, the history information may be the pattern of 0s and 1s of intra_pred_flag of a predetermined number of immediately preceding encoded points. For example, the predetermined number may be, but is not limited to, three. The points referred to for history are not limited to the immediately preceding encoded points and may be any processed (encoded or decoded) points.

Furthermore, this method can be combined with the process illustrated in FIG. 4. With this combination, it may be possible to improve encoding efficiency regardless of which between a multi-return mode and a single-return mode was used to obtain the point cloud to be processed.

In the above combination, the three-dimensional data encoding device may determine the context using the history information only if the counter value is a predetermined value such as 0. If the counter value is not the predetermined value, the device may determine the context according to the counter value without using the history information.

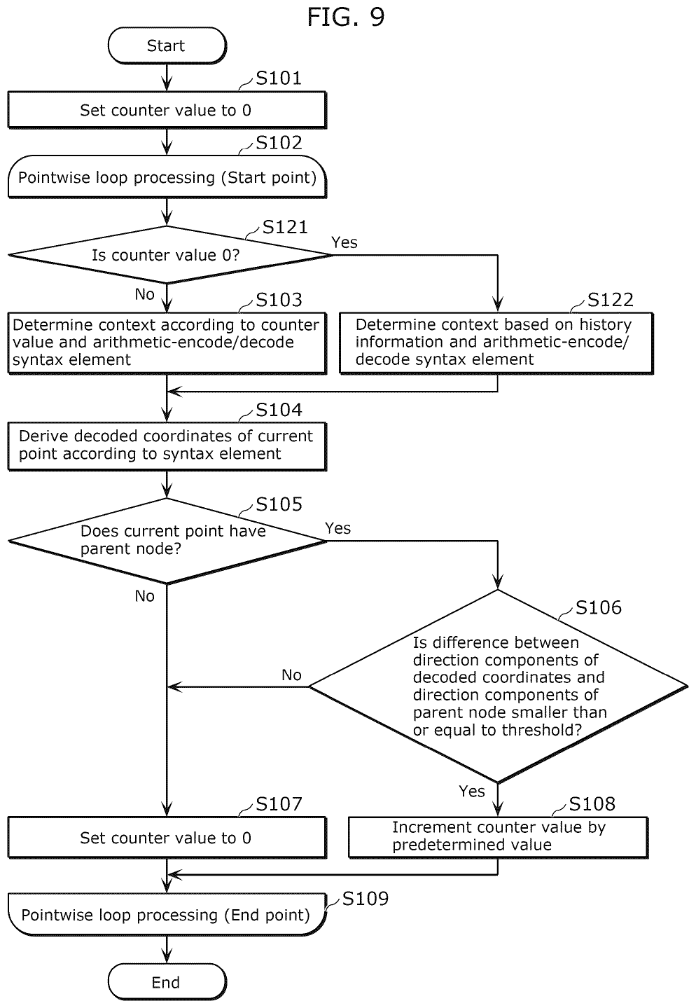

FIG. 9 is a flowchart illustrating an example of a procedure of arithmetic-encoding or arithmetic-decoding a syntax element corresponding to the current point in the above case. The process shown in FIG. 9 is the process shown in FIG. 4 with steps S121 and S122 added thereto. At step S121, the three-dimensional data encoding device determines whether the counter value of the current point is 0. If the counter value of the current point is 0 (Yes at S121), the three-dimensional data encoding device determines the context based on the history information and, using the context determined, arithmetic-encodes the syntax element (S122). For example, each value of the history information may be assigned a context, so that the three-dimensional data encoding device may select, from multiple contexts, the context corresponding to the value of the history information. To encode multiple syntax elements, the three-dimensional data encoding device may determine the context for each of the syntax elements. That is, the three-dimensional data encoding device may maintain history information for each of the syntax elements and, using the history information on a syntax element being processed, determine the context for the syntax element.

If the counter value of the current point is not 0 (No at S121), the three-dimensional data encoding device performs the processing at step S103 described above.

Here, if the context were to be set for each of the combinations of the counter values and the history information, the number of contexts required would be the number of possible values for the counter×the number of possible values for the history information. In contrast to this, using the history information only if the counter value is 0 as shown in FIG. 9 can reduce the number of contexts. Furthermore, with the process illustrated in FIG. 9, it may be possible to improve encoding efficiency regardless of which between a multi-return mode and a single-return mode was used to obtain the point cloud to be processed.

The history information may be updated each time a point is processed (encoded or decoded), or only if the counter value is the predetermined value such as 0. Specifically, in the process shown in FIG. 9, the history information may be updated at steps S103 and S122, or may be updated only at step S122, i.e., only information on points with the counter value 0 may be used as the history information. Updating the history information only at step S122 allows the history information to reflect only information on points expected to have high correlation. Accordingly, it may be possible to improve the encoding efficiency.

As described above, the prediction tree may be configured to branch at the first node in an angular direction and have the last node in the angular direction as a leaf node. The three-dimensional data encoding device may then determine, before performing step S103, whether the immediately preceding encoded node is a leaf. If the immediately preceding encoded node is a leaf, the three-dimensional data encoding device may determine the context using the history information. If the immediately preceding encoded node is not a leaf, the device may determine the context without using the history information. Determining the context without using the history information may be determining the context using the counter value or in other manners. Other manners may include, for example, using a common context. If the counter value is not used, steps S101 and S105 to S108 may be skipped.

If the prediction tree does not branch at the first node in an angular direction, the three-dimensional data encoding device may use the history information to determine the context for the node to be encoded next to the first node.

In the example shown in FIG. 9, the context is determined based on the history information if the counter value is 0. Alternatively, the context may be determined based on the history information if the counter value is any of one or more predetermined values. For example, in the example shown in FIG. 3, the context may be determined based on the history information if the counter value is 4, 5, or 0.

The above-described examples illustrate points at different distances in the same angular direction, obtained in a mode such as multi-return. Further, the above processing may be applied to the following case.

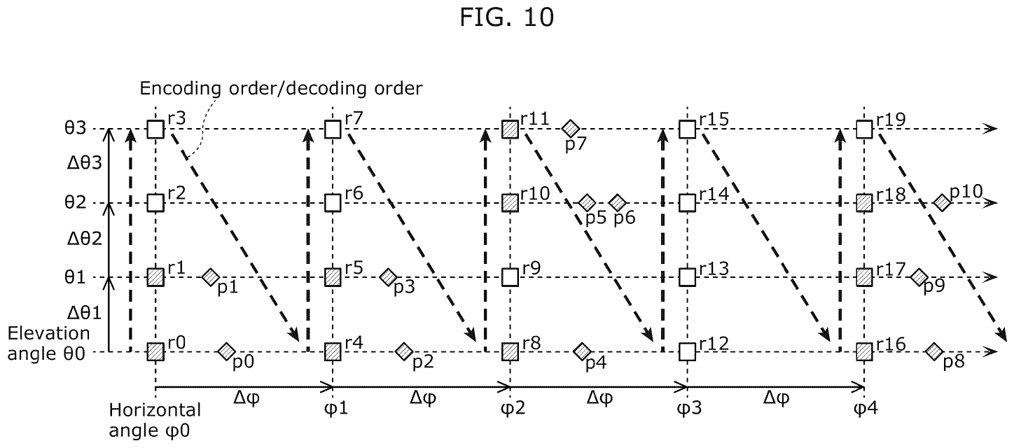

FIG. 10 is a diagram illustrating an encoding order (a processing order) of three-dimensional points (reference positions) in an encoding process. The three-dimensional data encoding device generates transform information by transforming position information included in input point cloud data to be encoded. Specifically, the three-dimensional data encoding device generates information for associating reference positions with three-dimensional points. The three-dimensional data encoding device also transforms the position information on each three-dimensional point using the corresponding reference position. For example, the transform information is the difference between the reference position and the position information on the three-dimensional point. The three-dimensional data encoding device performs the above-described encoding process for the transform information.

The three-dimensional data decoding device reproduces the position information by performing, for the transform information obtained by decoding a bitstream, inverse transform with respect to the transform processing performed by the three-dimensional data encoding device.

In FIG. 10, a horizontal direction represents horizontal angle ϕ in polar coordinates, and a vertical direction represents elevation angle θ in the polar coordinates. The three-dimensional data encoding device sets reference positions rm (m=0, 1, 2, . . . ) (also referred to as reference points). Here, reference positions rm are each expressed with horizontal angle ϕ and elevation angle θ. In other words, reference positions rm are each expressed with two components (θ, ϕ) out of three components (d, θ, ϕ) that express a position information item on a three-dimensional point. In addition, in the example illustrated in FIG. 10, reference positions rm indicated by squares in the figure are set based on sampling interval Δϕ that is a horizontal sampling interval of LiDAR and scan-line interval Δθk of LiDAR (k=1, 2, 3). In other words, the reference positions are set based on combinations of predetermined horizontal angles and elevation angles and disposed on a plane expressed by horizontal angle ϕ and elevation angle θ in a matrix pattern. In the example illustrated in FIG. 10, intervals Δϕ between horizontal angles ϕj (j=0, 1, 2, . . . ) of the reference positions are constant. Intervals between elevation angles θk (k=0, 1, 2, 3) of the reference positions can be set individually.

The three-dimensional data encoding device performs an encoding process (a transform process) on points pn (n=0, 1, 2, . . . ) indicated by rhombi located in the vicinities of the reference positions in an order indicated by dashed arrows in the figure. Hatched squares indicate first reference positions where points referring to the reference positions are present, and squares not hatched indicate second reference positions where points referring to the reference positions are not present.

The points referring to the reference position are points based on the reference positions. The points are associated with the reference positions (encoded (transformed) using the reference positions) as will be described later. In addition, the points referring to the reference positions are each a point of which values of horizontal angle ϕ and elevation angle θ are included within their respective ranges including the corresponding reference position. For example, the points referring to the reference positions are points pn that have horizontal angles being greater than or equal to ϕj and less than ϕj+Δϕ and are on the same scan line (have the same elevation angle). The range in horizontal angle is not limited to this. The range in horizontal angle may be, for example, greater than or equal to ϕj−Δϕ/2 and less than ϕj+Δϕ/2.

The processing order (encoding order) illustrated in FIG. 10 is based on processing units (corresponding to columns in FIG. 10) each consisting of reference positions having horizontal angles of the same value (e.g., r0 to r3), and in each processing unit, the reference positions are processed (encoded) in an order based on the elevation angle (ascending order in FIG. 10). The processing units (corresponding to the columns in FIG. 10) are processed in an order based on the horizontal angle (ascending order in FIG. 10). In other words, the reference positions are processed in ascending order of elevation angle for each set of reference positions having horizontal angles of the same value. The reference positions may be processed in ascending order of horizontal angle for each set of reference positions having elevation angles of the same value.

In encoding (transforming) of a target point, the three-dimensional data encoding device generates information for identifying a position (ϕj, θk) of reference position rm that is referred to by target point pn. The three-dimensional data encoding device generates an offset (ϕₒn, θₒn) from the reference position to the target point and information for identifying distance information dn on the target point. Here, ϕₒn is a difference between horizontal angle ϕj of the reference position and a horizontal angle of the target point, and θₒn is a difference between elevation angle θk of the reference position and an elevation angle of the target point.

The information for identifying the position of the reference position that is referred to by the target point, offset (ϕₒn, θₒn) from the reference position to the target point, and the information for identifying distance information dn on the target point each may be information for identifying a difference value from a predicted value generated based on processed information or may be information for identifying the value itself.

Three-dimensional data encoding device 100 may also store sampling interval Δϕ that is a horizontal sampling interval of LiDAR and scan-line interval Δθk of LiDAR in a bitstream. For example, the three-dimensional data encoding device may store Δϕ and Δθk in a header of an SPS or a GPS. Accordingly, the three-dimensional data decoding device can set the reference positions, using Δϕ and Δθk.

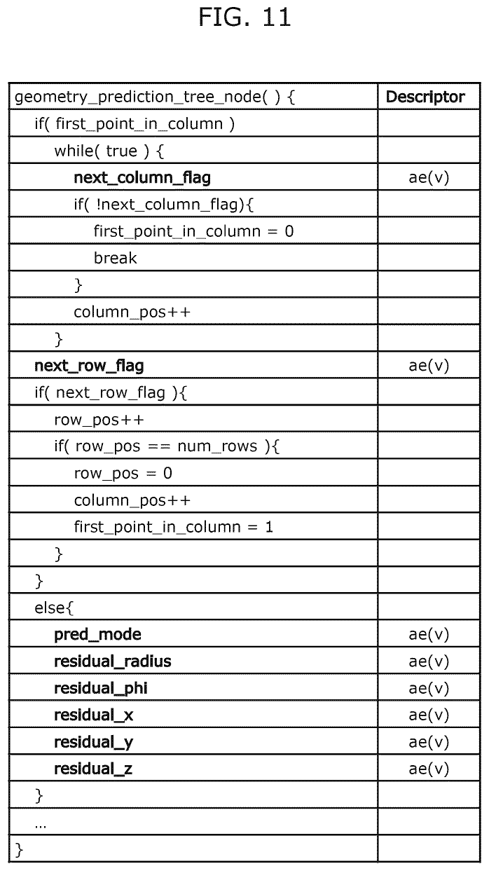

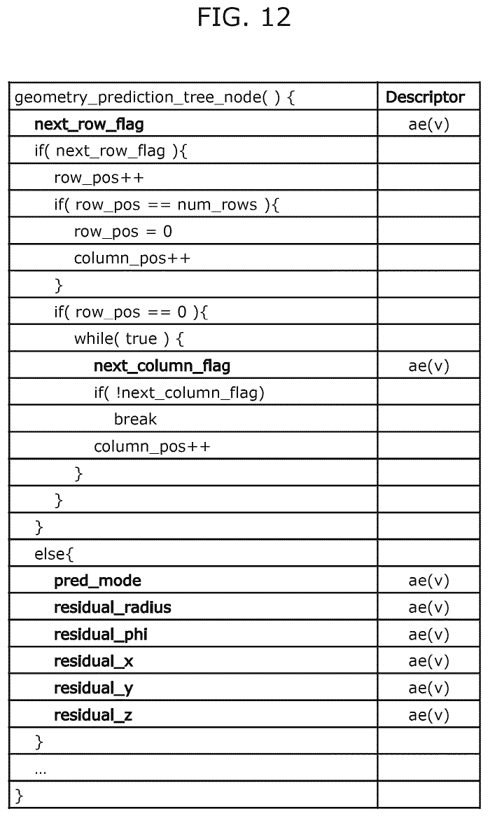

Next, syntax of the geometry information will be described. FIG. 11 is a diagram illustrating an example of a syntax of geometry information item on each point. In syntax examples shown in FIG. 11 and FIG. 12, parameters (signals) stored in a bitstream are written in bold type. The three-dimensional data encoding device repeatedly applies this syntax for each reference position rm to generate column_pos, which indicates an index of horizontal angle ϕj of reference position rm serving as a reference for point pn to be processed next, and row_pos, which indicates an index of elevation angle θk of reference position rm, and further generates parameter relating to point pn.

In this example, the three-dimensional data encoding device initializes variables before processing a first point. Specifically, the three-dimensional data encoding device sets first_point_in_column, which indicates a first piece of syntax corresponding to horizontal angles ϕj, to 1, sets column_pos to 0, and sets row_pos to 0. Alternatively, the three-dimensional data encoding device may notify the three-dimensional data decoding device of a value of column_pos and a value of row_pos of the first point, in advance of syntax corresponding to the first point. In this case, the three-dimensional data encoding device and the three-dimensional data decoding device may apply this syntax, using these values after setting first_point_in_column to 0.

Next, the three-dimensional data encoding device generates next_column_flag at reference position rm corresponding to a position having an elevation angle being θ0 (i.e., in the case where first_point_in_column is 1). next_column_flag indicates whether there is one or more points based on horizontal angles ϕj corresponding to the position of reference position rm. In other words, next_column_flag indicates whether there is a point that refers to any one of reference positions having the same horizontal angle as horizontal angles ϕj of reference position rm. For example, in the case where there is one or more points based on horizontal angle ϕj corresponding to the position of reference position rm (e.g., horizontal angles ϕ0, ϕ1, ϕ2, and ϕ4 illustrated in FIG. 10), next_column_flag is set to 0, and in the case where there is no point based on horizontal angle ϕj corresponding to the position of reference position rm (e.g., horizontal angle ϕ3 illustrated in FIG. 10), next_column_flag is set to 1. next_column_flag is provided for each horizontal angle ϕj (for each column in FIG. 10).

By repeatedly generating next_column_flag until next_column_flag becomes 0, the three-dimensional data encoding device can generate information that enables identification of horizontal angle ϕj corresponding to point pn to be processed next (ϕ0+column_pos×Δϕ). Accordingly, it may be possible to reduce a code amount required to notify next_row_flag described below. Whether to notify next_column_flag can be determined by whether row_pos is 0, as will be shown in FIG. 12 described later. However, determination with first_point_in_column enables avoidance with the notification of next_column_flag, which is also unnecessary in the case where there are points at a position of row_pos being 0, and thus can reduce the code amount.

The three-dimensional data encoding device generates next_row_flag at each candidate position of reference position rm serving as a reference for point pn to be processed next. next_row_flag indicates whether there is point pn to be processed at a position of elevation angle θk. In other words, next_row_flag indicates whether there is a point that refers to reference position rm. For example, when there is point pn to be processed at a position of elevation angle θk, next_row_flag is set to 0 (e.g., r0 and r1 in FIG. 10), and when there is no point pn to be processed at a position of elevation angle θk (e.g., r2 and r3 in FIG. 10), next_row_flag is set to 1. next_row_flag is provided for each reference position.

When next_row_flag is 1, the three-dimensional data encoding device repeatedly applies the syntax illustrated in FIG. 11 to generate next_row_flag corresponding to each candidate position consecutively. By repeating this process until next_row_flag becomes 0, the three-dimensional data encoding device can generate information that enables identification of elevation angle θk corresponding to point pn to be processed next.

When row_pos reaches the number of scan lines (num_rows illustrated in FIG. 11), the process proceeds to next horizontal angle ϕj. At this time, the three-dimensional data encoding device sets row_pos to 0, increases column_pos by 1, and sets first_point_in_column to 1.

In the above-described manner, the three-dimensional data encoding device can generate the information items (next_column_flag and next_row_flag) that enable the identification of horizontal angle ϕj and elevation angle θk of reference position rm serving as the reference for point pn to be processed.

Subsequently, the three-dimensional data encoding device generates information relating to a distance of target point pn, information relating to an offset in horizontal angle from reference position rm to target point pn, and pred_mode, which is information relating to a prediction method for these parameters. Here, the information relating to the distance is, for example, residual residual_radius, which indicates a difference between the distance of the target point and a predicted value generated by a predetermined method. The information relating to the offset in horizontal angle is, for example, residual residual_phi, which indicates a difference between offset ϕₒn in horizontal angle and a predicted value generated by a predetermined method.

The predicted values are calculated based on, for example, information on a processed three-dimensional point. For example, the predicted values are at least some of parameters of one or more processed three-dimensional points located in the vicinity of the target point. In this example, the three-dimensional data encoding device omits generation of information relating to an offset in elevation angle assuming that an offset in elevation angle is always 0. However, the three-dimensional data encoding device may generate information relating to an offset in elevation angle from reference position rm to point pn to be processed and store the information in a bitstream. For example, the information relating to an offset in elevation angle is residual residual_theta, which indicates a difference between offset θₒn of an elevation angle and a predicted value generated by a predetermined method.

Next, another example of the syntax will be described. FIG. 12 is a diagram illustrating an example of the syntax of a geometry information item on each point. The three-dimensional data encoding device repeatedly applies this syntax for each reference position rm to generate column_pos, which indicates an index of horizontal angle ϕj of reference position rm serving as a reference for point pn to be processed next, and row_pos, which indicates an index of elevation angle θk of reference position rm, and further generates parameter relating to point pn. The example shown in FIG. 12 differs from the example shown in FIG. 11 in the method of generating next_row_flag and next_column_flag used for identifying the values of column_pos and row_pos.

In this example, the three-dimensional data encoding device first initializes variables before applying the syntax to a first point. Specifically, the three-dimensional data encoding device notifies the three-dimensional data decoding device of a value of column_pos and a value of row_pos of the first point, in advance of syntax corresponding to the first point. In other words, for example, the three-dimensional data encoding device stores the value of column_pos and the value of row_pos of the first point in a bitstream. the three-dimensional data encoding device and the three-dimensional data decoding device apply the syntax with these values.

Next, the three-dimensional data encoding device generates next_row_flag for reference position rm at a position indicated by next_row_flag and next_column_flag and notifies the three-dimensional data decoding device whether there is point pn based on reference position rm at the position.

When next_row_flag is 1, the three-dimensional data encoding device first increases row_pos by 1. Next, the three-dimensional data encoding device determines whether row_pos has reached the number of scan lines (num_rows shown in FIG. 12). When row_pos reaches the number of scan lines, the three-dimensional data encoding device sets row_pos to 0 and increases column_pos by 1, determining that a candidate position is to be shifted to next horizontal angle ϕj. Next, the three-dimensional data encoding device determines whether row_pos is 0. When row_pos is 0, the three-dimensional data encoding device generates one or more next_column_flag and repeatedly increases column_pos by 1 until next_column_flag becomes 0. Thereafter, the three-dimensional data encoding device repeatedly applies the syntax shown in FIG. 12 until next_row_flag becomes 0.

When next_row_flag is 0, the three-dimensional data encoding device determines the values indicated by next_row_flag and next_column_flag at the time to be an index of horizontal angle ϕj and an index of elevation angle θk of reference position rm serving as a reference for point pn to be processed next and stores parameters relating to point pn to be processed next (e.g., pred_mode, residual_radius, residual_phi, residual_x, residual_y, and residual_z shown in FIG. 12) in a bitstream as in the example shown in FIG. 11. Horizontal angle ϕj can be calculated by ϕ0+column_pos×Δϕ, using values of the indices and sampling interval Δϕ that is a horizontal sampling interval of LiDAR. Elevation angle θk can be calculated, using the values of the indices and scan-line interval Δθk of LiDAR.

In the case where the transform between the coordinate systems is not performed, residual_x, residual_y, and residual_z need not be included in the bitstream. residual_theta may be included in the bitstream.

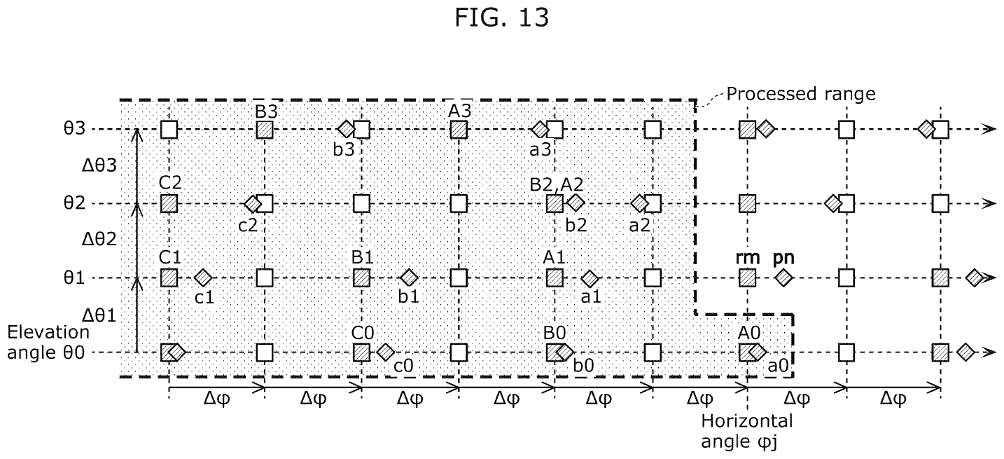

Next, an arithmetic encoding processing of next_row_flag will be described. FIG. 13 is a diagram for describing an example of a method for selecting a context (a probability table) in arithmetic encoding of next_row_flag. Reference position rm indicated in FIG. 13 is a reference position corresponding to next_row_flag to be encoded.

Entropy encoder 104 can use information items about reference positions included in a processed range indicated by shading surrounded by broken lines in FIG. 13 for the encoding process on next_row_flag corresponding to reference position rm. For example, entropy encoder 104 retains, in a memory, a predetermined number of one or more first reference positions at which points that are processed recently at each scan line and refer to the reference positions (e.g., hatched squares such as reference positions A0, B0, and C0 on a scan line of elevation angle θ0). Based on one or more information items about the one or more first reference positions retained in the memory, entropy encoder 104 switches among contexts used for arithmetic encoding of next_row_flag.

For example, entropy encoder 104 uses an information item about at least one of reference positions A1, B1, and C1 that are located on the same scan line as reference position rm. Specifically, entropy encoder 104 may use a difference in column_pos between at least one of reference positions A1, B1, and C1 and reference position rm. For example, entropy encoder 104 may use a difference in column_pos between reference position A1 closest to reference position rm and reference position rm. Alternatively, entropy encoder 104 may use a combination of the difference in column_pos between reference position A1 being closest to reference position rm and reference position rm and a difference in column_pos between reference position B1 being next closest to reference position rm and reference position rm. In this manner, entropy encoder 104 may determine a context in accordance with whether one or more reference positions located on the same scan line as reference position rm are first reference positions (whether there are one or more points referring to the one or more reference positions). Here, in point cloud data obtained by LiDAR, for example, points located on the same scan line may have a high correlation. Therefore, by referring to information on the points located on the same scan line to select a context, the selection of a context can be performed appropriately.

Alternatively, entropy encoder 104 may use an information item about a first reference position that is processed most recently (e.g., reference position A0). Specifically, entropy encoder 104 may switch among contexts in accordance with the number of times next_row_flag is 1 consecutively from reference position A0 to reference position rm. Alternatively, entropy encoder 104 may switch among contexts in accordance with row_pos of reference position rm itself rather than the information items about reference positions retained in the memory.

The above-described context determination method based on the counter value may be applied to the method described with reference to FIGS. 10 to 13. For example, in a point cloud such as one obtained in the multi-return mode, points at different distances may align in the same angular direction (e.g., at each of the horizontal angles ϕ0 to ϕ3). For these points, next_row_flag of the value 0 is consecutively encoded, and then next_row_flag of the value 1 is encoded when the process transitions to the next angular direction. This poses a problem in that, when next_row_flag of the value 1 is encoded, the context is already updated for next_row_flag of the value 0 and therefore the code amount cannot be reduced.

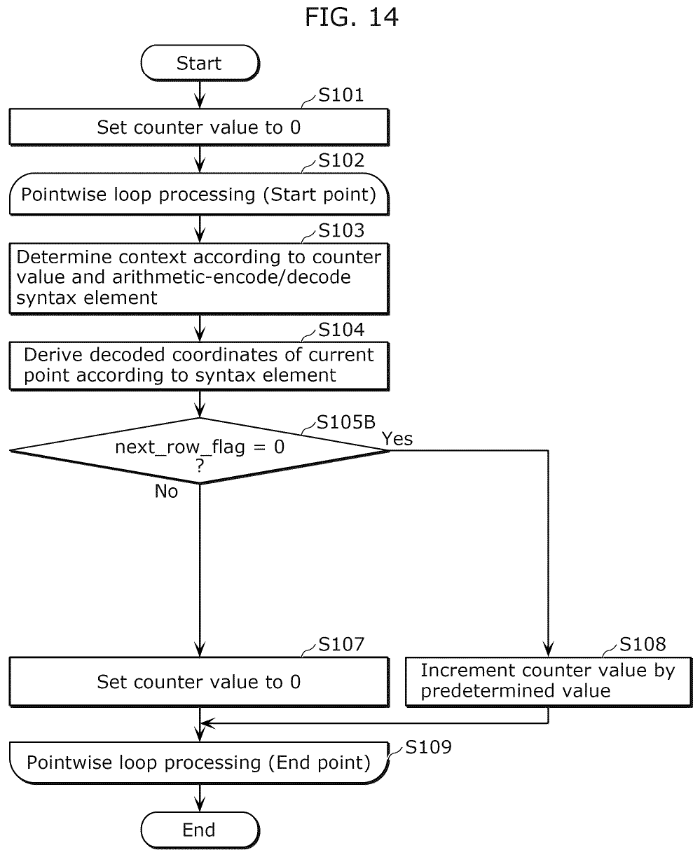

To address this, the context determination method based on the counter value can be used to reduce the code amount. FIG. 14 is a flowchart illustrating a variation of the procedure of arithmetic-encoding or arithmetic-decoding a syntax element corresponding to the current point. The process shown in FIG. 14 is different from the process shown in FIG. 4 in that it includes S105B instead of steps S105 and S106.

As shown in FIG. 14, instead of performing the determination processing at steps S105 and S106 in FIG. 4, the three-dimensional data encoding device determines whether next_row_flag is 0 (S105B). If next_row_flag is not 0 (No at S105B), the three-dimensional data encoding device performs step S107. If next_row_flag is 0 (Yes at S105B), the device performs step S108.

Thus, for example, the contexts used for points with smaller counter values are updated to a state suitable for frequently selected next_row_flag of the value 0. The contexts used for points with greater counter values are updated to a state suitable for next_row_flag of the value 1, or to a state that is neutral for both next_row_flag of the value 0 and next_row_flag of the value 1. This can improve the encoding efficiency of next_row_flag when the process transitions to the next angular direction, while maintaining the encoding efficiency of encoding next_row_flag of the value 0. Accordingly, it may be possible to improve the encoding efficiency for the bitstream as a whole.

The context determination method for next_row_flag based on information such as the information on the processed reference point described with reference to FIG. 11 may be combined with the context determination method for next_row_flag based on the counter value. With this combination, it may be possible to improve encoding efficiency regardless of which between a multi-return mode and a single-return mode was used to obtain the point cloud to be processed.

In the above combination, the three-dimensional data encoding device may determine the context using information such as the information on the processed reference point only if the counter value is a predetermined value such as 0. If the counter value is not the predetermined value, the device may determine the context according to the counter value without using information such as the information on the processed reference point. This can prevent an increase in the number of contexts. The three-dimensional data encoding device may update the stored information on processed reference points each time a point is encoded or decoded, or alternatively, only if the counter value is the predetermined value such as 0. In the latter case, the three-dimensional data encoding device can allow the stored information on processed reference points to reflect only information on points expected to have high correlation. Accordingly, it may be possible to improve the encoding efficiency.

The syntax element for which the context is selected according to the counter value in the process shown in FIG. 14 is, for example, at least one of the syntax elements shown in FIG. 11 or 12. For example, the three-dimensional data encoding device may select, according to the counter value, a context for next_row_flag shown in FIG. 11 or 12. This can reduce the memory capacity required for storing the contexts.

It should be noted that all processes described with reference to FIG. 4, FIG. 6, FIG. 9, or FIG. 14 are not always necessary, and it is acceptable that only part of these processes are performed.

In the above-described examples, the context to be used in the arithmetic encoding involved in the entropy encoding is selected according to the counter value. Alternatively, the method of binarization involved in the entropy encoding may be changed. For example, 0 and 1 of an output signal (a binary signal) in a transform table used for binarization may be interchanged according to the counter. When the same context is used for both a first point at which the value 0 frequently occurs and a second point at which the value 1 frequently occurs, the signal at the second point at which the value 1 frequently occurs can be transformed from the value 1 to the value 0, for example. As a result, the occurrence frequency of the value 0 of a signal to be arithmetic-encoded (a binarized signal) is high in either case. Thus, it may be possible to improve the encoding efficiency even when the same context is used. For example, for points with counter values greater than a threshold, the three-dimensional data encoding device may use a first binarization method. For points with counter values smaller than or equal to the threshold, the device may use a second binarization method that interchanges 0 and 1 of the output signal in the first binarization method.

It should be noted that in the decoding processing of the three-dimensional decoding device, the method of binarization included in the entropy encoding described above is replaced with the method of de-binarization in entropy decoding.

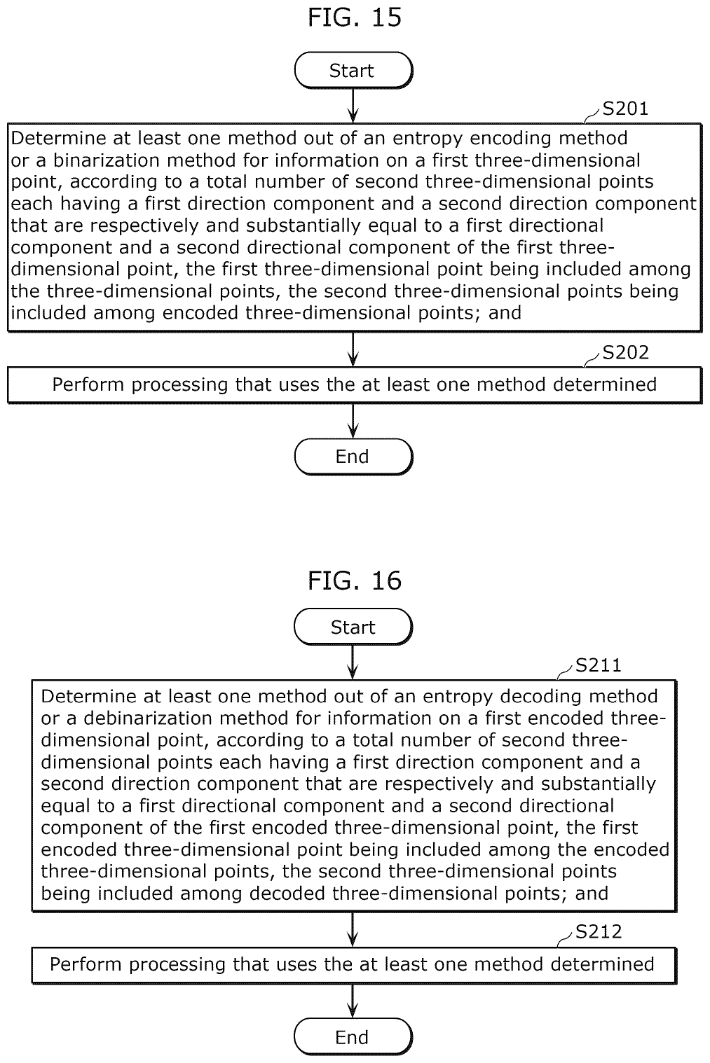

As described above, the encoding device (three-dimensional data encoding device) according to the present embodiment performs the process illustrated in FIG. 15. The encoding device encodes three-dimensional points each having position information including a distance component, a first direction component, and a second direction component (for example, a horizontal angle component and an elevation angle component). The encoding device determines at least one method out of an entropy encoding method or a binarization method for information on a first three-dimensional point, according to a total number (for example, a counter value) of second three-dimensional points each having a first direction component and a second direction component that are respectively and substantially equal to a first direction component and a second direction component of the first three-dimensional point, the first three-dimensional point being included among the three-dimensional points, the second three-dimensional points being included among encoded three-dimensional points (S201); and performs processing that uses the at least one method determined (S202).

Accordingly, the total number of decoded second three-dimensional points is reset upon switching of a direction component. In response, the encoding device switches at least one method out of the entropy encoding method or the binarization method. Switching of a direction component means that at least one of the first direction component or the second direction component is switched. The encoding device can thus select, for example, at least one method out of the entropy encoding method or the binarization method as appropriate for the switching of the direction component, and thus encoding efficiency can be improved. It should be noted that direction components being substantially equal to each other means that the difference between the direction components is smaller than or equal to a threshold, for example.

For example, in the determining of the at least one method out of the entropy encoding method or the binarization method (S201), the encoding device determines the context to be used in arithmetic encoding, and, in the processing (S202), the encoding device arithmetic-encodes the information on the first three-dimensional point using the context determined.

Accordingly, the encoding device can switch the context to be used in arithmetic decoding according to the switching of the direction component. Accordingly, for example, the encoding device can select a context that is suitable to the switching of the direction component, and thus encoding efficiency can be improved. It should be noted that entropy encoding is not limited to arithmetic encoding. For example, entropy encoding may be Huffman encoding.

For example, the information (for example, intra_pred_flag) on the first three-dimensional point indicates which between an inter prediction mode and an intra prediction mode is to be used. For points having substantially equal direction components (the first direction component and the second direction component), the intra prediction mode tends to be consecutively selected. Therefore, by switching the at least one method out of the entropy encoding method or the binarization method according to the switching of the direction component, encoding efficiency can be improved.

For example, the information (quantized_1st_residual_value) on the first three-dimensional point indicates the prediction residual of the first direction component or the second direction component. Here, with points for which the direction components (first direction component and second direction component) are substantially the same, the prediction residual tends to decrease. Therefore, by switching the at least one method out of the entropy encoding method or the binarization method according to the switching of the direction component, encoding efficiency can be improved.

For example, the residual value of the first direction component or the second direction component (quantized_1st_residual_value) is information obtained by quantizing a prediction residual of a horizontal angle component. Here, with points for which the direction components (first direction component and second direction component) are substantially the same, the prediction residual of the horizontal angle component tends to decrease. Therefore, by switching the at least one method out of the entropy encoding method or the binarization method according to the switching of the direction component, encoding efficiency can be improved.

For example, the total number is the total number of second three-dimensional points having substantially the same horizontal angle component as the first three dimensional point. For example, when encoding is performed by sequentially scanning points in the horizontal angle direction, switching of the direction component can be determined using only the horizontal angle component. Furthermore, by performing the determining using only the horizontal angle component, the processing amount can be reduced.

For example, the total number is a total number of the second three-dimensional points each having a quantized first direction component and a quantized second direction component that are respectively and substantially equal to a quantized first direction component and a quantized second direction component of the first three-dimensional point. For example, the total number is the total number of second three-dimensional points having a quantized horizontal angle component that is substantially equal to a quantized horizontal angle of the first three-dimensional point.

For example, in the determining of the at least one method out of the entropy encoding method or the binarization method, the encoding device clips the total number of the second three-dimensional points, and determines the at least one method out of the entropy encoding method or the binarization method for the information on the first three-dimensional point according to the clipped total number. Accordingly, for example, in the case of switching methods for each total number, the number of methods to be used can be reduced, and thus the processing amount or the memory capacity to be used can be reduced.

For example, in the determining of the at least one method out of the entropy encoding method or the binarization method, the encoding device quantizes the total number of the second three-dimensional points, and determines the at least one method out of the entropy encoding method or the binarization method for the information on the first three-dimensional point according to the quantized total number. Accordingly, for example, in the case of switching methods for each total number, the number of methods to be used can be reduced, and thus the processing amount or the memory capacity to be used can be reduced.

For example, in the determining of the at least one method out of the entropy encoding method and the binarization method, when the total number is not within a predetermined range (for example, No in S121 in FIG. 9), the encoding device determines the at least one method out of the entropy encoding method and the binarization method for the information on the first three-dimensional point according to the total number of the second three-dimensional points (for example, S103), and when the total number is within the predetermined range (for example, Yes in S121), the encoding device determines the at least one method out of the entropy encoding method and the binarization method for the information on the first three-dimensional point according to history information based on information on the encoded three-dimensional points (for example, S122). For example, the predetermined range may be consecutive values, or non-consecutive values, or a single value. For example, in the example illustrated in FIG. 9, the predetermined range includes on a value 0.

Accordingly, even if there are cases where switching methods according to the total number is not effective, the encoding device can select an appropriate method using the history information. Furthermore, since the number of methods to be used can be reduced compared to the case of switching the method for each combination of a total number and history information, the processing amount or the memory capacity to be used can be reduced.

For example, the history information is the total number of 0s or 1s or the pattern of the 0s and 1s in the information on the encoded three-dimensional points. Accordingly, the encoding device can select an appropriate method according to the total number of 0s or 1s or the pattern of the 0s and 1s in the information on the encoded three-dimensional points.

For example, the history information is updated with the information on an encoded three-dimensional point for which the total number is a predetermined value, and is not updated with the information of an encoded three-dimensional point for which the total number is other than the predetermined value. Accordingly, for example, the encoding device can allow the history information to reflect information on points expected to have high correlation, and thus encoding efficiency can be improved.

For example, the information (for example, next_row_flag) on the first three-dimensional point indicates whether a three-dimensional point corresponding to a reference position is present. Here, at the time of switching of the direction component, information indicating whether a three-dimensional point corresponding to a reference position is present tends to be a specific value. Therefore, by switching the at least one method out of the entropy encoding method or the binarization method according to the switching of the direction component, encoding efficiency can be improved.

For example, the smaller the total number, the encoding device arithmetic-encodes the information on the first three-dimensional point using a context that is suitable for the information on the first three-dimensional point indicating that a three-dimensional point corresponding to the reference position is present. Specifically, when the total number is a first value, the encoding device arithmetic-encodes the information on the first three-dimensional point using a first context, and when the total number is a second value smaller than the first value, the encoding device arithmetic-encodes the information on the first three-dimensional point using a second context that is more suitable than the first context for the information on the first three-dimensional point indicating that a three-dimensional point corresponding to the reference position is present

For example, the encoding device includes a processor and memory, and the processor performs the above processes using the memory.

Furthermore, the decoding device (three-dimensional data decoding device) according to the present embodiment performs the process illustrated in FIG. 16. The decoding device decodes encoded three-dimensional points each having position information including a distance component, a first direction component, and a second direction component (for example, a horizontal angle component and an elevation angle component). The decoding device determines at least one method out of an entropy decoding method or a debinarization method for information on a first encoded three-dimensional point, according to a total number (for example, a counter value) of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points (S211); and performs processing that uses the at least one method determined (S212).

Accordingly, the total number of decoded second three-dimensional points is reset upon switching of a direction component (first direction component or second direction component). In response, the decoding device switches at least one method out of the entropy decoding method or the debinarization method. The decoding device can thus select, for example, at least one method out of the entropy decoding method or the debinarization method as appropriate for the switching of the direction component. The decoding device can therefore appropriately decode a bitstream encoded with an improved encoding efficiency. The improved encoding efficiency of the bitstream can also reduce the amount of data handled in a decoding device. It should be noted that direction components being substantially equal to each other means that the difference between the direction components is smaller than or equal to a threshold, for example.

For example, the decoding device, in the determining of at least one method out of the entropy decoding method or the debinarization method (S211), determines a context to be used in arithmetic decoding; and in the processing (S212), arithmetic-decodes the information on the first encoded three-dimensional point using the context determined.

Accordingly, the decoding device can switch, according to the switching of the direction component, the context to be used in arithmetic decoding. The decoding device can thus select, for example, a context suitable for the switching of the direction component. The decoding device can therefore appropriately decode a bitstream encoded with an improved encoding efficiency. The improved encoding efficiency of the bitstream can also reduce the amount of data handled in the decoding device. It should be noted that the entropy decoding is not limited to arithmetic decoding. For example, the entropy decoding may be Huffman decoding.

For example, the information (for example, intra_pred_flag) on the first encoded three-dimensional point indicates which between an inter prediction mode and an intra prediction mode is to be used. For points having substantially equal direction components (the first direction component and the second direction component), the intra prediction mode tends to be consecutively selected. The decoding device thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the information (quantized_1st_residual_value) on the first encoded three-dimensional point indicates a prediction residual of the first direction component or the second direction component. For points having substantially equal direction components (first direction component and second direction component), the prediction residual tends to decrease. The decoding device thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the prediction residual (quantized_1st_residual_value) of the first direction component or the second direction component is information obtained by quantizing a prediction residual of a horizontal angle component.

For points having substantially equal direction components (the first direction component and the second direction component), the prediction residual of the horizontal angle component tends to decrease. The decoding device thus switches at least one method out of the entropy decoding method or the debinarization method according to the switching of the direction component, and can therefore appropriately decode a bitstream encoded with an improved encoding efficiency. The improved encoding efficiency of the bitstream can also reduce the amount of data handled in the decoding device.

For example, the total number is the total number of second three-dimensional points having substantially the same horizontal angle component as the first three dimensional point. For example, when decoding is performed by sequentially scanning points in the horizontal angle direction, switching of the direction component can be determined using only the horizontal angle component. Furthermore, by performing the determining using only the horizontal angle component, the processing amount can be reduced.

For example, the total number is a total number of the second three-dimensional points each having a quantized first direction component and a quantized second direction component that are respectively and substantially equal to a quantized first direction component and a quantized second direction component of the first encoded three-dimensional point. For example, the total number is the total number of second three-dimensional points having a quantized horizontal angle component that is substantially equal to a quantized horizontal angle of the first encoded three-dimensional point.

For example, in the determining of the at least one method out of the entropy decoding method and the debinarization method (S211), the decoding device clips the total number of the second three-dimensional point, and determines the at least one method out of the entropy decoding method and the debinarization method for the information on the first three-dimensional point according to the clipped total number. Accordingly, for example, in a case where the method is switched on a per total number basis, the number of methods to be used can be reduced, and thus the processing amount and the memory capacity to be used can be reduced.

For example, in the determining of the at least one method out of the entropy decoding method and the debinarization method (S211), the decoding device quantizes the total number of the second three-dimensional point, and determines the at least one method out of the entropy decoding method and the debinarization method for the information on the first three-dimensional point according to the quantized total number. Accordingly, for example, in a case where the method is switched on a per total number basis, the number of methods to be used can be reduced, and thus the processing amount and the memory capacity to be used can be reduced.

For example, in the determining of the at least one method out of the entropy decoding method and the debinarization method (S211), when the total number is not within a predetermined range (for example, No in S121 in FIG. 9), the decoding device determines the at least one method out of the entropy decoding method and the debinarization method for the information on the first three-dimensional point according to the total number of the second three-dimensional points (for example, S103), and when the total number is within the predetermined range (for example, Yes in S121), the decoding device determines the at least one method out of the entropy decoding method and the debinarization method for the information on the first three-dimensional point according to history information based on information on the decoded three-dimensional points (for example, S122). For example, the predetermined range may be consecutive values, or non-consecutive values, or a single value. For example, in the example illustrated in FIG. 9, the predetermined range includes on a value 0.

Accordingly, even if there are cases where switching methods according to the total number is not effective, the decoding device can select an appropriate method using the history information. Furthermore, since the number of methods to be used can be reduced compared to the case of switching the method for each combination of a total number and history information, the processing amount or the memory capacity to be used can be reduced.

For example, the history information is the total number of 0s or 1s or the pattern of the 0s and 1s in the information on the decoded three-dimensional points. Accordingly, the decoding device can select an appropriate method according to the total number of 0s or 1s or the pattern of the 0s and 1s in the information on the decoded three-dimensional points.

For example, the history information is updated with the information on an decoded three-dimensional point for which the total number is a predetermined value, and is not updated with the information of an decoded three-dimensional point for which the total number is other than the predetermined value. Accordingly, for example, the decoding device can allow the history information to reflect information on points expected to have high correlation. The decoding device can therefore appropriately decode a bitstream encoded with an improved encoding efficiency. The improved encoding efficiency of the bitstream can also reduce the amount of data handled in the decoding device.

For example, the information (for example, next_row_flag) on the first three-dimensional point indicates whether a three-dimensional point corresponding to a reference position is present. Here, at the time of switching of the direction component, information indicating whether a three-dimensional point corresponding to a reference position is present tends to be a specific value. Therefore, by switching the at least one method out of the entropy encoding method or the binarization method according to the switching of the direction component, encoding efficiency can be improved.

For example, the smaller the total number, the decoding device arithmetic-decodes the information on the first three-dimensional point using a context that is suitable for the information on the first three-dimensional point indicating that a three-dimensional point corresponding to the reference position is present. Specifically, when the total number is a first value, the decoding device arithmetic-decodes the information on the first three-dimensional point using a first context, and when the total number is a second value smaller than the first value, the decoding device arithmetic-decodes the information on the first three-dimensional point using a second context that is more suitable than the first context for the information on the first three-dimensional point indicating that a three-dimensional point corresponding to the reference position is present

For example, the decoding device includes a processor and memory, and the processor performs the above processes using the memory.

For example, the encoding device encodes three-dimensional points each having position information including a distance component, a first direction component, and a second distance component (for example, a horizontal angle component and an elevation angle component). The encoding device determines at least one method out of an entropy encoding method and a binarization method for information on the first three-dimensional method according to whether or not a point encoded immediately before a first three-dimensional point corresponds to a leaf node in a prediction tree, and performs processing that uses the method determined.

Here, the node at the time of switching of the direction component tends to be a leaf node. Therefore, the encoding device can switch the at least one method out of an entropy encoding method and a binarization method according to the switching of the direction component. Accordingly, the encoding device can select the at least one method out of an entropy encoding method and a binarization method which suitable for the switching of the direction component, and thus encoding efficiency can be improved.

For example, in the determining, the encoding device determines a context to be used in arithmetic encoding, and in the processing, the encoding device arithmetic-encodes the information on the first three-dimensional point using the context determined.

For example, in the determining, when the point encoded immediately before the first three-dimensional point corresponds to the leaf node, a first context is selected, and when the point encoded immediately before the first three-dimensional point does not correspond to the leaf node, a second context is selected. The first context is more suitable to inter prediction than the second context.

Here, inter prediction tends to be used for a point after the switching of the direction component. Accordingly, the encoding device can improve encoding efficiency.

For example, the encoding device encodes three-dimensional points each having position information including a distance component, a first direction component, and a second distance component (for example, a horizontal angle component and an elevation angle component). The encoding device entropy-encodes or binarizes, using a first method of at least one of entropy encoding or binarization, the information on a first three-dimensional point to be encoded first among three-dimensional points for which the value of the first direction component is the same. The encoding device entropy-encodes or binarizes, using a second method of at least one of entropy encoding and binarization, the information on a second three-dimensional point which is other than the first three-dimensional point among the three-dimensional points for which the value of the first direction component is the same. The second method of entropy encoding is different from the first method of entropy encoding, and the second method of binarization is different from the first method of binarization.

Here, processing different from other points tends to be performed on a point after the switching of the first direction component. Therefore, the encoding device can improve encoding efficiency by using a different method at the time of switching of the first direction method.

For example, in the entropy encoding or the binarization of the information on the first three-dimensional point, the encoding device arithmetic-encodes the information on the first three-dimensional point using a first context, and in the entropy encoding or the binarization of the information on the second three-dimensional point, the encoding device arithmetic-encodes the information on the second three-dimensional point using a second context different from the first context.

For example, the first context is suitable for inter prediction, and the second context is suitable for intra prediction. Here, there is a tendency to use inter prediction for a point after the switching of the first direction component, and to use intra prediction for other points. Therefore, the encoding device can improve encoding efficiency.

For example, the first direction component is a horizontal direction component.

For example, the encoding device encodes three-dimensional points each having position information including a distance component, a first direction component, and a second distance component (for example, a horizontal angle component and an elevation angle component). When a first three-dimensional point corresponds to a leaf node in a prediction tree, the encoding device determines at least one method out of an entropy encoding method and a binarization method for information on the first three-dimensional point according to history information based on information on encoded three-dimensional points.

Accordingly, the encoding device can select an appropriate method by using the history information, and thus encoding efficiency can be improved.

For example, when the first three-dimensional point does not correspond to a leaf node, the encoding device determines the at least one method out of an entropy encoding method and a binarization method for the information on the first three-dimensional point according to a total number (for example, the counter value) of second three-dimensional points for which differences in the first direction component and the second direction component with the first three-dimensional point are less than or equal to a threshold.

For example, the decoding device decodes three-dimensional points each having position information including a distance component, a first direction component, and a second distance component (for example, a horizontal angle component and an elevation angle component). The decoding device determines at least one method out of an entropy decoding method and a debinarization method for information on the first three-dimensional method according to whether or not a point decoded immediately before a first three-dimensional point corresponds to a leaf node in a prediction tree, and performs processing that uses the method determined.

Here, the node at the time of switching between the first direction component and the second direction component tends to be a leaf node. Therefore, the decoding device can switch the at least one method out of an entropy decoding method and a debinarization method according to the switching of the direction component. Accordingly, the decoding device can select the at least one method out of an entropy decoding method and a debinarization method which suitable for the switching of the direction component. Accordingly, the decoding device can appropriately decode a bitstream for which encoding efficiency has been improved. Furthermore, since the encoding efficiency for the bitstream is improved, the amount of data handled in the decoding device can be reduced.

For example, in the determining, the decoding device determines a context to be used in arithmetic decoding, and in the processing, the decoding device arithmetic-decodes the information on the first three-dimensional point using the context determined.

For example, in the determining, when the point decoded immediately before the first three-dimensional point corresponds to the leaf node, a first context is selected, and when the point decoded immediately before the first three-dimensional point does not correspond to the leaf node, a second context is selected. The first context is more suitable to inter prediction than the second context.

Here, inter prediction tends to be used for a point after the switching of the direction component. Accordingly, the decoding device can appropriately decode a bitstream for which encoding efficiency is improved. Furthermore, since the encoding efficiency for the bitstream is improved, the amount of data handled in the decoding device can be reduced.

For example, the decoding device decodes three-dimensional points each having position information including a distance component, a first direction component, and a second distance component (for example, a horizontal angle component and an elevation angle component). The decoding device entropy-decodes or debinarizes, using a first method of at least one of entropy decoding or debinarization, the information on a first three-dimensional point to be decoded first among three-dimensional points for which the value of the first direction component is the same. The decoding device entropy-decodes or debinarizes, using a second method of at least one of entropy decoding and debinarization, the information on a second three-dimensional point which is other than the first three-dimensional point among the three-dimensional points for which the value of the first direction component is the same. The second method of entropy decoding is different from the first method of entropy decoding, and the second method of debinarization is different from the first method of debinarization.

Here, processing different from other points tends to be performed on a point after the switching of the first direction component. Accordingly, the decoding device can appropriately decode a bitstream for which encoding efficiency has been improved. Furthermore, since the encoding efficiency for the bitstream is improved, the amount of data handled in the decoding device can be reduced.

For example, in the entropy decoding or the debinarization of the information on the first three-dimensional point, the decoding device arithmetic-decodes the information on the first three-dimensional point using a first context, and in the entropy decoding or the debinarization of the information on the second three-dimensional point, the decoding device arithmetic-decodes the information on the second three-dimensional point using a second context different from the first context.

For example, the first context is suitable for inter prediction, and the second context is suitable for intra prediction. Here, there is a tendency to use inter prediction for a point after the switching of the first direction component, and to use intra prediction for other points. Therefore, the decoding device can appropriately decode a bitstream for which encoding efficiency has been improved. Furthermore, since the encoding efficiency for the bitstream is improved, the amount of data handled in the decoding device can be reduced.

For example, the first direction component is a horizontal direction component.

For example, the decoding device decodes three-dimensional points each having position information including a distance component, a first direction component, and a second distance component (for example, a horizontal angle component and an elevation angle component). When a first three-dimensional point corresponds to a leaf node in a prediction tree, the decoding device determines at least one method out of an entropy decoding method and a debinarization method for information on the first three-dimensional point according to history information based on information on decoded three-dimensional points.

Accordingly, since the decoding device can select an appropriate method by using history information, the decoding device can appropriately decode the bitstream for which encoding efficiency is improved. Furthermore, since the encoding efficiency of the bitstream is improved, the amount of data handled in the decoding device.

For example, when the first three-dimensional point does not correspond to a leaf node, the decoding device determines the at least one method out of an entropy decoding method and a debinarization method for the information on the first three-dimensional point according to a total number (for example, the counter value) of second three-dimensional points for which differences in the first direction component and the second direction component with the first three-dimensional point are less than or equal to a threshold.

A three-dimensional data encoding device (encoding device), a three-dimensional data decoding device (decoding device), and the like, according to embodiments of the present disclosure and variations of the embodiments have been described above, but the present disclosure is not limited to these embodiments, etc.

Note that each of the processors included in the three-dimensional data encoding device, the three-dimensional data decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as a three-dimensional data encoding method (encoding method), a three-dimensional data decoding method (decoding method), or the like executed by the three-dimensional data encoding device (encoding device), the three-dimensional data decoding device (decoding device), and the like.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

A three-dimensional data encoding device, a three-dimensional data decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to a three-dimensional data encoding device and a three-dimensional data decoding device.

1. A decoding method for decoding encoded three-dimensional points each having position information including a distance component, a first direction component, and a second direction component, the decoding method comprising:
determining at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and
performing processing that uses the at least one method determined.

2. The decoding method according to claim 1, wherein
in the determining, a context to be used in arithmetic decoding is determined; and
in the processing, the information is arithmetic-decoded using the context determined.

3. The decoding method according to claim 1, wherein
the information indicates which between an inter prediction mode and an intra prediction mode is to be used.

4. The decoding method according to claim 1, wherein
the information indicates a prediction residual of the first direction component or the second direction component.

5. The decoding method according to claim 4, wherein
the prediction residual is information obtained by quantizing a prediction residual of a horizontal angle component.

6. The decoding method according to claim 1, wherein
the total number is a total number of the second three-dimensional points each having a quantized first direction component and a quantized second direction component that are respectively and substantially equal to a quantized first direction component and a quantized second direction component of the first encoded three-dimensional point.

7. The decoding method according to claim 1, wherein
in the determining, the total number is clipped at a predetermined upper limit, and the at least one method is determined according to the total number clipped.

8. The decoding method according to claim 1, wherein
in the determining, the total number of the second three-dimensional points is quantized, and the at least one method is determined according to the total number quantized.

9. The decoding method according to claim 1, wherein
in the determining:
when the total number is not within a predetermined range, the at least one method is determined according to the total number; and
when the total number is within the predetermined range, the at least one method is determined according to history information based on information on the decoded three-dimensional points.

10. The decoding method according to claim 9, wherein
the history information is a total number of 0s or 1s or a pattern of the 0s and the 1s in the information on the decoded three-dimensional points.

11. The decoding method according to claim 9, wherein
the history information is updated with the information on a decoded three-dimensional point for which the total number is a predetermined value, and is not updated with the information of a decoded three-dimensional point for which the total number is other than the predetermined value.

12. The decoding method according to claim 1, wherein
the information indicates whether a three-dimensional point corresponding to a reference position is present.

13. An encoding method for encoding three-dimensional points each having position information including a distance component, a first direction component, and a second direction component, the encoding method comprising:
determining at least one method out of an entropy encoding method or a binarization method for information on a first three-dimensional point, according to a total number of second three-dimensional points each having a first direction component and a second direction component that are respectively and substantially equal to a first direction component and a second direction component of the first three-dimensional point, the first three-dimensional point being included among the three-dimensional points, the second three-dimensional points being included among encoded three-dimensional points; and
performing processing that uses the at least one method determined.

14. A decoding device that decodes encoded three-dimensional points each having position information including a distance component, a first direction component, and a second direction component, the decoding device comprising:
a processor; and
memory, wherein
using the memory, the processor:
determines at least one method out of an entropy decoding method or a debinarization method for information on a first encoded three-dimensional point, according to a total number of second three-dimensional points each having a first direction component and a second direction component that are respectively and substantially equal to a first direction component and a second direction component of the first encoded three-dimensional point, the first encoded three-dimensional point being included among the encoded three-dimensional points, the second three-dimensional points being included among decoded three-dimensional points; and
performs processing that uses the at least one method determined.
